(19) United States
(12) Patent Application Publication
(10) Pub. No.: US 2022/0198957 A1
(43) Pub. Date: Jun. 23, 2022

(54) Trading Psychology Development

(71) Applicant: Trade Support, Lehi, UT (US)

(72) Inventors: Matthew Edward Poll, Bluffdale, UT (US); Kevin Charles Jones, Salem, UT (US)

(73) Assignees: Matthew Edward Poll, Bluffdale, UT (US); Kevin Charles Jones, Salem, UT (US)

(21) Appl. No.: 17/128,024

(22) Filed: Dec. 19, 2020

(51) Int. Cl. G09B 19/18; G06Q 40/04; G09B 5/14; G09B 5/12

(52) U.S. Cl. CPC G09B 19/18; G09B 5/12; G09B 5/14; G06Q 40/04

(57) ABSTRACT

Investing or trading, herein referred to as trading, is recognized worldwide as a means to financial success, as well as failure. Among the various widely accessible financial markets there are highly successful participants among many with poor or failed experience. Within each market there is widely available fundamental market information and analysts, more than a couple hundred common trading aids or indicators and expert advisors, dozens of brokerage firms with their market support, and other such commonly accessible market participation elements. Again, some participants thrive, while others experience marginal success or failure. Undoubtedly, some markets and relevant information, technology, tools, and techniques, among other supportive elements are better than others. Given what is equally accessible to all, there must remain another significant trading variable. That is the nature of the trader or trade psychology. Disclosed herein is a method of trading psychology development for surprisingly enhanced market participation.

### CROSS-REFERENCE TO RELATED APPLICATIONS

Multi-Faceted Trading Education, Provisional application number 62/943,284 filed Dec. 4, 2019.

### STATEMENT REGARDING FEDERALLY SPONSORED RESEARCH OR DEVELOPMENT

Not applicable.

### REFERENCE TO A SEQUENCE LISTING

Not applicable.

### COPYRIGHT STATEMENT

All written and graphic representation in this patent document are subject to copyright protection under the copyright laws of the United States and other countries. The copyright owner has no objection to the reproduction of a patent, patent application, or invention disclosure if retained as a complete document as published by the copyright owner, government, or found in a government record. Otherwise all other copyright provisions whatsoever are reserved.

### ABSTRACT

Separately submitted.

### BACKGROUND OF THE INVENTION

### Field of the Invention

This invention generally involves the participation in the financial markets with its associated technology, tools, techniques, and tips while recognizing that Trade Psychology Development as a central contributor to the determination of degrees of trading success and failure.

### Problem Statement

Investing or trading, or generally “trading” in the financial markets relies upon doing so in the anticipated direction of increased instrument value in the market. The term financial market is ascribed to any activity formally organized to exchange ownership, responsibility, or value of an instrument by way of use of monetary exchange. Monetary exchange being different from that of deriving value from material, labor, land, bartering, or other form of value exchange. A financial market instruments today commonly takes the form of equities or stocks, bonds and other sovereign government promissory notes, currency pair comparative value, agricultural or mineral yields, derivatives thereof, and so on.

Markets establish policies that represent tangibles or agreed value creation that requires administration of the exchange among participants. Given common interest in various instruments, both a location and facilitators of exchange were needed. Initially this took the form of an agreed upon location in a community and eventually to a specific location dedicated to that instrument, called a trading floor. Consider this infrastructure as forming the market. Facilitators of exchange on that floor became known as brokers acting on behalf of others near and far to the consolidated location of exchange for a particular instrument. Much of our terminology and practices have emerged from this period of concentrated instrument location trading. With modern information technology, physical trade locations for an instrument have largely dissolved and moved to a virtual online location. This became an environment of dispersed infrastructure by way of software, servers, computers, devices, internet and intranet connectivity and other information technology from the market to brokers to the local user and their combinations With this infrastructure connectivity, Brokers have largely moved online and remain integral as consolidators of activity with a financial instrument.

Important to realize is that financial markets are derived from the outlook and perspective of individuals acting in their own best self-interest or in the best self-interest of an organization. Given the myriad of individual and organization participants and their best self-interest circumstances, market knowledge, experience, available assets, and so forth; the outlook of a market conditions is seen differently. Combine this with external economic, competitive, personnel, country, regional, and other factors there are substantial and varied forces acting upon market by participants and therefore ultimately a somewhat unknown market behavior. As such, anticipating the direction of the aggregate value of an instrument in the market is unpredictable and uncertain given the many and various forces and perspectives upon the market.

Attempts at ascertaining a somewhat random market behavior of an instrument has taken on various forms. These have largely been categorized as fundamental analysis or technical analysis. Fundamental analysis involves the use of market external news and information to assess potential general market or instrument specific influences that may affect coming behavior. Technical analysis attempts the use market data and parameters to ascertain future market direction. With technical analysis, many take the approach of assessing historical and current market price information. Such an approach is generally known as price action participation. Others look towards the use of mathematical manipulation of various forms and sources of historical and current market data. These mathematical approaches to analysis can be referred to as indicators. These many tools and attempts to objectify the market seek to create a machine-like quality to trading. Despite these attempts there remains the human factor that places a subjective filter and behavior between these objective tools, techniques, signals, and other trading aids and the traders market participation.

Ultimately through the many decades of participating in the market from its most informal origins to its current mature experience, extensive use of mathematics, and information technology-based format, the outcomes of market participation success can still be mixed. An active search for informed and executed trade science or skill and trade art or temperament has been sought. Disclosed is an innovative Trading Psychology Development system and process to achieve an enhanced trading outcome.

### State of the Art Assessment

Participating in financial markets is now widely available beyond institutions and the well-resourced to essentially all individuals. As broad as the variances in individuals, this is a likeness of the variance in readiness of individuals to participate in the markets. In part this is due to a lack of access points to a trading education.

The most ideal entrance into the market occurs with formally educated individuals that then work professionally with a firm or individual with years of experience, systems, tools, and tips as to how to best participate in a given market. Undoubtedly, a relevant formal education combined with on-the-job training, certification, tutoring, mentoring, apprenticeship, and other guided education and experience is likely to create an informed, capable, and likely more successful market participate in an institutional role or as an individual. Expectedly, the number of individuals with such a career or professional intention followed by successful participation institutionally are comparatively small.

Most individuals seeking to participate in the financial markets do so from largely an experimental starting point. They may have picked up some ideas here and there and then open an account, fund it with a few discretionary dollars, and experiment in the market. Of course, part of this individual attempt at trading for many involves some education. Today, likely most of that is through video, online content, books, and so forth. Many that seek this route for financial market participation do so to avoid the costs of paid education programs. However, it is not unusual that this self-taught approach can be have its own costs in lost revenue due to the long time to learn to participate in the markets and often from the high costs of many or bigger mistakes in the markets. History shows that despite these laudable efforts that there still remains something missing for these self-taught traders. For the vast number of these individuals, their success is limited and often leads to losses or discomfort with the market and their elimination from participation. This is unfortunate as it is for this reason that a many are not as successful as they wish to be in the markets and ultimately word gets out that trading is risky, only a few are successful, and such.

Other more fortunate individuals may have access to others that have made the leap into successful market participation by one way or another. For most of these individuals their initial thoughts are they have a path to successful market participation. What most find is that traders are not as accessible for mentorship as they expected, even with close relationships. Traders are busy trading. Trade training takes time and effort over an extended period. Although not an accurate and realistic thought, as the more participants there are in the markets the better the financial markets become, some trading mentors may not want to share their trading techniques. Further, new financial market participants need to realize that approaching a known successful market participant, that they will be receiving just one perspective towards the market, all be it successful for that person. As a whole, even though one may know of a successful participant in the market, that is not often as sure a way into successful market participation as expected.

The challenge still remains, how do most people gain entry into the financial markets as a trader. Again, most will not have the benefit of related formal education and work experience, self-study is proven time consuming and unreliable, and access to known successful market participants has shown them to be less accessible than would be expected. What is left is the use of paid private individual or institutional instructions. Many market participant hopefuls are reluctant to want to pay for such services, but many do ultimately realize this may be their most timely and reliable access to market participation. The type and quality of such programs does vary, as expected. Many of these are individual market participants that train other as an aspect of leveraging their knowledge and experience in trading. Although they provide access, they still only provide one perspective towards market participation. Further, as one individual there still may remain limited access to trainers with more proven market success. This limitation shows up in many forms as there is only so much that an individual trainer can accomplish as far as offering individual attention, video content, regular webinars, and so forth. Other offerings may be from institutions that broaden financial market perspective to various trainers, if such access is programed or granted. Whether an individual or institutional financial market trading education, many of these are influenced by profit making forces. This likely shows up first in having more than one student being instructed at a time, possible limits on instruction duration and access, and so on.

Disclosed herein is the Applicant's multi-faceted trading education that recognized the limitations of trading information access and provides a system to address the shortfalls common to the participation in the financial markets as discussed. The Applicant uniquely combines aspects of self-study with training and trading elements, individualized coaching with training and trading instruction and activity, group training and trading education, event and webinar training and trading, group participation through events and a device-based chat application, and more. Important to this innovative system is both participant and group assessments of The Participants development for successful participation in the financial markets as a trader. The Participant continues to participate in aspects of the Applicant's multi-faceted trading education until such time as The Participant through self-assessment and with information of group assessments The Participant is able to determine their readiness for financial market trading participation. This is an accessible approach with the benefits of both individualized and group contribution for a surprisingly effective participant trading outcome in the financial markets. An outcome that shows improved trading outcomes beyond that of typical trading outcomes.

An important additional component to the Applicants multi-faceted trading education and experience that provides surprising improved trading outcomes due to information awareness, skill development, and tool and technique advantages, there is also the inclusion of Trading Psychology Development. Regardless of any refinement, advancements, advantages, and other superior aids and skill to market participation, without trading psychology development the potential of the aids and skill will not be fully realized. Often the difference between market success and failure is the interference of the human element and the variability of the specific trader's personal proclivities and character. There are many sources of appropriate and sufficient information for successful participation in the market, but disclosed herein is the Applicant's Trading Psychology Development system and process that create surprising enhanced trading outcomes well beyond typical trading outcomes.

### BRIEF SUMMARY OF THE INVENTION

The Applicant discloses an effective means of Trading Psychology Development by way of a multi-faceted trading education system and process that incorporates the using of the Applicant's real money. The result is a surprisingly effective and enhanced trading participation in the financial markets whether The Participant had previous trading experience or no previous trading experience.

This innovation takes readily available market infrastructure of software, servers, computers, connectivity, and other information technology from the market to the local user to also include data, and interface portals through brokerage firms and data manipulation services to uniquely participate in the financial markets. First a financial market is chosen and an appropriate brokerage firm is selected to interface in the market. The Applicant uniquely assesses market data by way of its proprietary mathematical algorithms to manipulate market data for unique signals suggesting anticipated market behavior. The Applicant's mathematical algorithms are provided to a data manipulation service for conversion into charted into local graphical and numeric trade signals for use by Applicant prospects, students, and group members. These signals in combination with general financial market data in the form of price movement represented by what the financial market knows as candlesticks. With general market data, unique market signals, and access to the markets the foundation of the Applicant's multi-faceted trading education system and process is resources and participants are able to uniquely access and participate in the financial markets.

As a definitional clarification, student is inclusive, but not limited to a person under the instruction of the Applicant's coaches, trainers, and mentors, also referred to collectively as instructors. A student refers generally to Applicant's group or members as all are students when trading the markets. The term participant is also used herein as is included within the definition of a student as well as retains its own implication of one generally involved in the markets.

The Applicants Multi-Faceted Trading Education begins with any individual being able to assess the Applicant's trading process and system through a Trial Trading Education And Experience. This is a full system assessment with Trial Education that includes learning the market basics, indicator and use basics, analysis software basics, trade placement basics. With some foundational information and knowledge, a prospect assessing the Applicant's day trading system can then actually enter the financial market with a practice account for Trial Trading Experience. That can include applying the basics of trade placement in the market with a practice account using the brokers trade portal, participating in basic training onsite and online webinars, participating in basic onsite and online trading webinars, communicate with other prospects through general participation but also a basic group chat, and access to general support. The Prospect simply cycles through trading education and experience until The Prospect and The Group assess they are ready for more formal Certified Trading Education And Training.

The Applicant's multi-faceted trading education system and process is essentially for providing the tools through indicators and signals and techniques through information and educational to provide means and skill to create improved trading outcomes in the financial markets. The Applicant's multi-faceted trading education starts with a prospect trying the Applicant's trading system and process in a trial education and trial trading experience. This provides a means for The Prospect to assess many aspects of trading generally, evaluating the Applicant's trading system, and even determining their fit with the Applicants group and culture. The Prospect has the opportunity to determine their interest in pursuing trading generally and specifically with the applicant as being well-informed as to the Applicant and their market trading approach.

With mutual assessment between the Applicant Group and The Prospect to continue, the now student enters the Applicant's certified trading education and trading experience system and process for readiness to participate in the markets. This process includes access to general and Applicant enhanced market participation technology and tools, as well as the benefit of general best-practices and Applicant enhanced techniques and tips. Access begins with the Student benefiting from 1-to-1 personalized coaching, training, and mentoring. This is an important component of the Applicant's trading system and process because it not only imparts information, knowledge, and ultimately skill development, but it provide opportunity for the Applicant to specifically address the Student's personal proclivities towards proper trade psychology to be most successful in the application of tools and techniques for the greatest and even enhanced participation in the financial markets. The Student is further refined in their trading skill and psychology by participation in small group educational and experiential environments. Beyond continued skill development, the Student is able to witness the affects of trade psychology of others as demonstrated by their associated successes or failures in the market. A different context, a different perspective, as so forth provide a new awareness or new awakening of the importance of trading psychology and means of adjusting their own outlook, habits, and practices to gain improved trading outcomes. A further aspect of the Applicant's best mode in trading education and experience is going beyond personalized coaching that may occur onsite or remotely is that of 1-to-1 as well as side-by-side mastery coaching, training, and mentoring. Being in the same place in a side-by-side context that provides for 1-to-1 personal attention the Student gains further and even enhanced educational and experiential benefits and insights in the use of general and Applicant technology and tools, as well as general best practices and Applicant specific techniques and tips. Yet significantly in addition to enhanced trade skill applied outcomes is the further development of best trade psychology. Often the Student at this point has come with some understanding and practice beyond the mechanics of trading and is at a point to accept and apply additional trade skill and psychology to the markets. Here the coach, trainer, and mentor are able to address with the Student their specific trading psychology needs for the most significant participation in the financial markets. Now with a greater foundation in trading skill and psychology, the Student continues to advance with each through participation in larger expert training forums and events with the Applicant's most accomplished coaches, trainers, and mentors. As with the smaller group environment previously experienced by the Student, there is greater exposure to higher levels of trading skill disclosure and exchange of the influence of trading psychology on the outcomes of trades as expressed by the coaches, trainers, and mentors as well as from more experienced and expert group membership. The result is the Student's further elevation in trading skill development and trading psychology development. As expected the cycle of a trail experience, then a certified coaching curriculum, followed by a small group exposure, then added upon by a side-by-side personal mastery series, and interjected with regular larger group expert events, with the opportunity to cycle in an about each of these elements, the Student's trading skill and trading psychology are continuously enhanced and refined for demonstrated enhanced participation in the financial markets. There is a surprisingly effective financial market participation outcome from the Applicant's multi-faceted trading education system and process that addresses both trade skill and trade psychology readiness.

Importantly disclosed herein is the inclusion of an additional aspect of the Applicant's multi-faceted trading education and experience is the addition of students trading in the financial markets with the Applicant's money. It was noticed that the behavior of students transitioning from practice trading in the financial markets to real money trading resulted in noticeable addition of emotion in the trading character of The Participant. An educational system that includes practice trading in the financial markets is critical. However, including trading in the market with institutional money was found to allow students to enter the markets with a funded account with substantially less emotion and a more stable trade psychology. This results as there is not the personal connection to the funds. As such, the funds are perceived more objectively. This allows students to continue to trade the markets on a more fact-based perspective. Observed is greater market success. In time, the Student becomes comfortable in participating in the market with a funded account for surprisingly rapid transition into market success. They also more comfortably transition into trading privately funded accounts with their own money as they now have funded account experience in the markets and are aware of and are better managing the trade psychology associated with funded account trading in the markets. The ultimate result is not only improved financial market participation beyond typical market results, but an enhanced proprietary trading outcome.

### BRIEF DESCRIPTION OF THE SEVERAL VIEWS OF THE DRAWING

FIG. 1—Diagram Of Financial Markets And Applicant Trading Readiness Development Integration. The general financial market structure and disclosure interface into the market.

FIG. 2—Flow Chart Of Multi-Faceted Trading Education System With Applicant Funding. Additional perspective of how the Applicant's multi-faceted trading education with Applicant funded accounts create superior financial market participation.

FIG. 3—Flow Chart Of Multi-Faceted Trading Education Elements With Applicant Funding. Integration of Applicant funded accounts in the Applicant's multi-faceted trading education.

FIG. 4—Flow Chart Of Applicant Funding Process For Trading Psychology Development. The decision-making process to assess readiness for trading an Applicant funded account.

FIG. 5—Flow Chart Of Applicant Funding For Trading Psychology Development Elements. Specific key components of a minimal trade psychology appropriate for financial market trading.

FIG. 6—Flow Chart Of Applicant Additional Funding For Advanced Trading Psychology Development. Specific key components of increasing trade psychology with increases in an Applicant funded account.

### DETAILED DESCRIPTION OF THE INVENTION

### Principles of the Invention

There is increasing market participation by individuals who recognize the great potential in trading, balanced by known risks, given today's information and other technology, advancing trading tools, ever evolving techniques, and tips from those of more experience. It is arguably claimed that because of the aforementioned, that some of the simplest, cheapest, fastest, and most flexible monetary gains and wealth can be attributed to trading the markets. Hence, the continued interest in financial market participation.

Potential market participants seek market entry bay various means. Some come with formal education, others professionally trained and experienced, as well as across the spectrum to include amateurs through self-training and experimentation. An industry has also flourished providing trading education that many elect to utilize. It is observed however, that in many cases there may be little difference between any of these methods of market entry. This is the result that there is near universal emphasis on information access and skill development, with the lack of attention given to an equally important element of financial market participation. For market success, a participant needs appropriate trade information, trade skill, trade psychology, and trade funds. What is missing all too frequently is the development of trade psychology which can influence the success of any trading method regardless of the amount of trade support. Further, many new traders enter the market with such small accounts, prudently wise, that they really cannot develop a large enough account to maintain their interest for continued development.

Here the Applicant discloses a method for trading education that includes the effective development of trade psychology by way of Applicant funded accounts. These accounts provide for the benefits of trade psychology development that cannot be substituted by a practice account. A practice simply does not carry with it the emotions associated with trading a funded account in the financial markets. Further the Applicant can continue to provide additional funds to a trade account to continue to increase trade skill and trade psychology enhanced development.

Disclosed is a trading education system that provides proper skill development through information distribution as well as practice trading the financial markets. The culmination of this trading education and market practice experience is the determination by the Student and the Applicant that the Student is ready for a funded account. The Student trades the funded account and is immersed in the unique experience that draws out the Student's market character. The Student's education continues as a coach, trainer, or mentor works with the Student through additional skill development, but also through their feelings, demonstrated proclivities that reduce trade effectiveness. These attributes that can diminish trade results are many. It can include not being patient and entering a trade before they are properly developed. It might be staying in losing trades too long when it is rationally prudent to exit the trade. It is also manifest in getting nervous and cutting winning trade off too short and losing available profit. It is overtrading, risking too much in a trade, not protecting trades, doubling and tripling down on trades believing they know the direction of the market, it is behavior based on greed or fear. There are many factors within the realm of trade psychology. The proper development of trade psychology cannot be over emphasized.

Disclosed also, is not only the development of trade skill and trade psychology by the use of Applicant funded accounts, but there is also the further development of these needed traits. It may be accomplished by continued coaching, training, and mentoring as well as increasing the trade account. Each increase in the account carries with it a new sense towards the market. There is more to gain which calls out element of greed within The Participants character. That may cause new emotions and associated behaviors in greater trade risk and less patience to get to a greater return faster, among other manifestations with increased funding. It may also include adding increasing fear and trepidation that there is more to lose. This may be manifest with lack of trading, trading too small a position in the market, lack of clear thinking when in the markets, and other demonstrated negative trade temperament. Ultimately, the Applicant's use of a multi-faceted trading education combined with funded trade experience of increasing account magnitude results in the fastest and most competent total trade readiness with surprising enhance proprietary trading outcomes.

The principles of the invention are the recognized novelty and surprising results of Applicant's students using Applicant's money as part of the learning process to trade the financial markets. A student show a less emotional transition into the financial market participation by using a trade account funded with money to which they are less personally attached. Trading their own private funded trade account carries with it significant emotional and behavioral responses that impede the Student from clearly, patiently, and in a consistent and disciplined manner participate in the market. This interference to the clearer thinking of the Student to apply what they have learned from the Applicant's multi-faceted trading education results in unnecessary errors and losses, less confidence and hesitation in participating in the market, and among many other outcomes. Student's trading the Applicant's funded account are far less attached to the trade funds and are left with minimal emotional and behavioral interference allowing them to better apply the Applicant's multi-faceted trading education. Being less emotionally attached to the funds means being less emotionally attached to the trading outcome. This allows the Student to be more objective about their trading and to remain more open to learn from their trading experience to create a faster and more robust trading skill development and more refined further trading psychology development.

This upward cycle in trading skill and psychology ultimately results in a high performing or proprietary trading outcome. With this outcome the Student observes they are profitably participating in the market and are then more confident to enter the market with their own trading funds without significant emotional and behavior interference to their trading.

### DRAWING DESCRIPTION

The following drawings disclose the flow and manipulation of information and data then used to predict anticipated price movement to successfully participation in the financial markets.

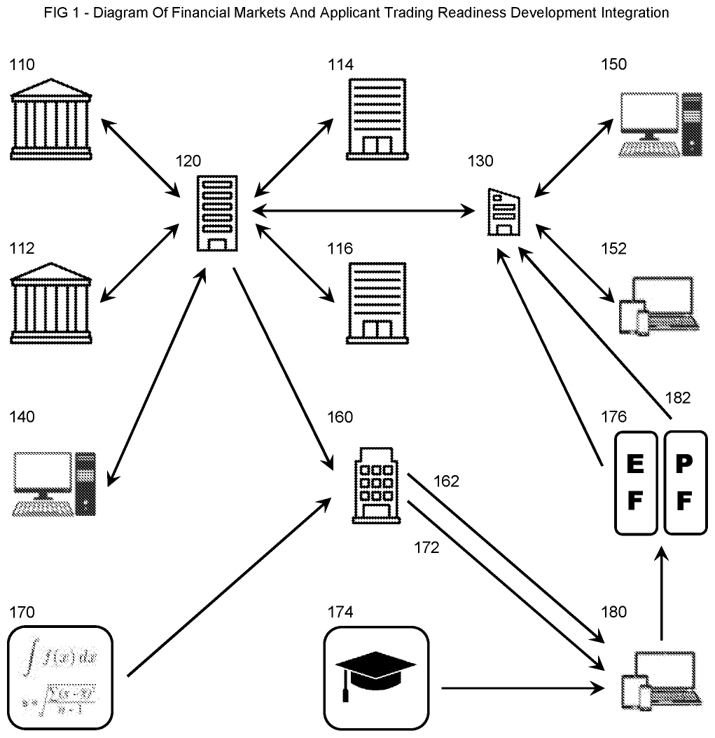

FIG. 1 is the Diagram Of Financial Markets And Multi-Faceted Trading Education Integration.

FIG. 1 shows there are various financial markets that have evolved from a local physical location-based presence and influence to now a more global access model through information technology and connectivity. Today, these various markets would share a generally common structure to provide market access to institutional and individual investors and traders, we will call institutional or individual participants or participants. Describing this general market structure would include Major Private Financial Institutions 110 that provide capital or capital assurances to form the financial liquidity in the markets. Their individual influence varies based upon their involvement in a particular market or markets, generally recognized significance by governments, industry, the markets, and others. In cases they can influence market value, specific instrument value and pricing, and other market specific elements. Other Major Public Participants 112 such as governments and regulatory agencies, industry associations and monitors, media and social forces, and like influences also contribute to the market. They can participate in the market by providing offerings, financing, interest rate and other market leverage, regulation and policy, and more. The Private Markets 114 represent aggregators of specific market assets and instruments and set the general policies and procedures for participation in their market. They have direct and substantial influence upon the operation of the market and other influences. These institutions provide the interface between the financial markets and the physical world and industry. Naturally, the influences of this physical world such as supply and demand, technology, services, natural influence such as weather, and more provide direct influence on the existence and behavior of the markets. There are Public Markets 116 administered by governments and agencies. They may be less speculative in their structure, but they do operate to make assets and instruments available to market participants. In times past and in rare occasions today, the markets were location based. Today, the vast majority of markets are online based. Market Connectivity 120 is the result of market specific and general connectivity infrastructure of servers, connections, protocols, and more with the financial markets, brokers, end users, and their combinations. In this diagram Market Connectivity 120 is represented as a single entity, but it should be interpreted that in is present and connecting all other diagram elements. It is simply redundant to represent such a fundamentally understood element to the financial market structure and this disclosure diagram. Represented is that Major Private Financial Institutions 110, Major Public Interests 112, Private Markets, and Public Markets interact cooperatively and competitively in a manner as to create the functioning markets. Needed are participants in the markets. They take the form of Major Self-Brokering Participants 140 that have direct access to the market based upon the volume of their participation, other contributions to the market, and other factors. Again, they participate in the market directly through their own market access. Given the characteristics of their participation in the markets, they can have an influence upon market behavior. The vast majority of market participants do so through a market intermediary or Broker 130. The Broker 130 facilitates market participation for lower volume Institutional Participants 150 and Individual Participants 152. Institutional Participants 150 represent large banks and financial institutions, endowments and funds, corporations and organizations, and individuals with equivalent resources that participate in the markets. They are not so involved in the markets as to participate as a Major Self-Brokering Participant, but their participation can have an impact on market behavior. The Broker 130 also services Individual Participants 152. This represents those with less volume participation and require and benefit from the services of a broker to access the markets. Their individual participation usually does not have an influence upon the market, but at times with sufficient collective sentiment, they can influence the market to some degree. They are to some degree sources of capital to the markets. This disclosure is not directed towards this generalized market structure discussed for reference and context. Further, other entities undoubtedly could be listed with a more granular discussion of the markets, but these key elements are sufficient to establish the connection of this disclosure to the markets.

FIG. 1 further discloses the use of a Market Data Manipulator 160 that receives market data and manipulates it to create tools and techniques to provide users the ability to analyze the markets to take position and participate in the markets. A Major Self-Brokering Participant 140, a Broker 130, an Institutional Participant 150, and an Individual Participant 152 may use their own methods of data manipulation or use an outside resource such as a Market Data Manipulator 160 to provide tools and techniques to better assess and participate in the markets. Such is the case with this disclosure. A Market Data Manipulator 160 is used for their Market Data and Analysis Software 162 that provides charted market data and analysis tools. A Market Data Manipulator 160 with the capacity to accept general or even the Applicant's mathematical algorithms 170 is used to create Trade Indicators 172 to assess historical, current, and anticipated market behavior. The combination of Market Data and Analysis Software 162 and Trade Indicators 172 provides a uniquely accurate assessment of anticipated market behavior are used by an Applicant Group Member 180 to identify market positions and participation that are then placed with a chosen Broker 130. The Applicant Group Member 180 can participate in the markets through the Broker 130 using an Applicant Trading Educational Real Money Account 176 or the Applicant Member's Private Trade Fund 182. What is disclosed is the use of the Trade Indicators 172 with Applicant Trading Education 174 and Applicant Trading Education Real Money Account 176 through appropriate connectivity to the market as previously discussed herein to facilitate the Applicant Group Member 180 to day trade the markets with surprisingly successful results using an Applicant Trading Educational Real Money Account 176 or a Privately Funded Account 182.

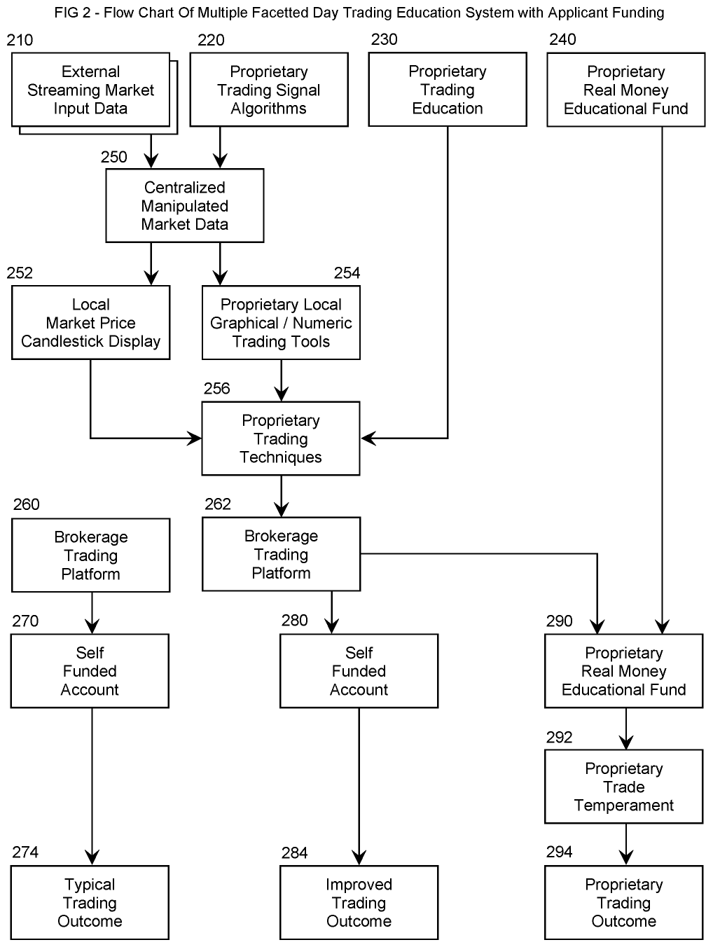

FIG. 2 is the Flow Chart Of Multi-Faceted Trading Education System.

FIG. 2 was previously and generally disclosed as Applicant Trading Education FIG. 1 172. Here the Applicant's Trading System of FIG. 1 172 is discussed in detail as the subject of this disclosure. For contrast, FIG. 2 briefly illustrates that the typical path of participation in the market for most Individual Participants FIG. 1 150 takes the form of interfacing with a Brokerage Trade Platform 260 online using a Private Self-Funded Account 270 and results in a Typical Trading Outcome 274. A typical result refers to what a person having ordinary skill in the art of market participation. That person is not referring to those professionally trained and participating in the markets with an institution account and institutional level of market awareness and advantage. The person of ordinary skill in the art is the individual who is self-trained, trained by an acquaintance, or has trained with a relevant service provider and is participating in the market as a lay, amateur, or non-professional. The Typical Trading Outcome 274 of this market participant is not widely successful and has led to a social perspective about financial market participation as being risky, not successful, that a few can profit while many will lose money, and so on. So prevalent is this perspective that governments and their agencies require disclosure of caution and warning. These may include such statements as “previous results are not indicative of future results,” “market participation is risky and is not right for all,” and so on. What is disclosed is a system of Trade indicators here identified as Local Graphical/Numeric Proprietary Signals 254 and Proprietary Trade Education 256 while using either a Self-Funded Account 280 or a Proprietary Real Money Education Fund 290 will result in surprisingly uncommon successful participation in the financial markets.

FIG. 2 reviewed in detail starts with a simplified representation of the financial markets as specifically interfacing with the Applicant's Multi-Faceted Trading Education System including key elements of General And/Or Proprietary Trade Signal Algorithms 220, Proprietary Day Trade Education 230, and Proprietary Real Money Trading 240. This figure uses the term “Trade” throughout. The term “Trade” takes upon it the usual meaning of participating in the financial markets. More specifically referring to a participation on a shorter-term basis that may be for minutes, hours, days, and weeks. In this disclosure “Trade” is also encompassing of what is inclusive of the term “Investing.” Where “Investing” has a definition and understanding to represent more of a longer-term participation in the markets of months to years. Again, “Trading” is intended to be inclusive of all and any form of participation in the financial markets and for any and all financial markets. External Streaming Market Input Data 110 is representative of the totality of FIGS. 1 110, 112, 114, 116, and 120, and related players and infrastructure from which various sources arrives to the Centralized Manipulated Market Data 250 provider also represented in FIG. 1 160. The Centralized Manipulated Market Data 250 provider also accepts the General And/Or Proprietary Trade Signal Algorithms 220 as also represented by FIG. 1 170. The result is both typical market data in the form of Local Market Price Candlestick Display 252 and as shown by FIG. 1 162 and associated charting and tools, but also Local Graphical and Numeric Proprietary Signals 254 and as shown by FIG. 1 172. The term local represents that data, connectivity, and data manipulation occurring elsewhere in the market structure are provided by online connectivity to an Individual Participant FIG. 1 152 or even to an Institutional Participant FIG. 1 150 at their location or on their personal computer or trade station. The individual or institutional market participant then receives the Applicant's Proprietary Trading Techniques 256 enhanced by Applicant Proprietary Day Trade Education 230 as also represented in FIG. 1 174 and through their computer 256 and as detailed in FIG. 1 180 use a Brokerage Trade Platform 262 and as shown in FIG. 1 130 that facilitates a Proprietary Real Money Educational Fund 240 and 290 and as shown in FIG. 1 176 or a Self Funded Account 280 and a shown in FIG. 1 182 to execute trades and participate in the markets. The combination of General And/Or Proprietary Trade Signal Algorithms 220 in the useable form of Local Graphical and Numeric Proprietary Signals 254 to create Applicant Proprietary Trading Techniques 256 when catalyzed with understanding and best practices by Applicant proprietary Day Trade Education 230 are used as a system for Improved Trading Outcome 284. The Improved Trading Outcome 284 results from surprisingly accurate anticipated financial market direction and magnitude movement as a trade declaration of market entry price, market exit profit price, and market exit stop loss price. Improved Trading Outcomes 284 represents outcome greater than that of Typical Trading Outcomes 274. Again, the Typical Trading Outcomes 274 are representative of essentially a barely succeeding outcome that has resulted in a societal perspective of trading as being acknowledge as possible and profitable for some, but likely a losing situation for most. That places Improved Trading Outcomes 284 as more successful than the Typical Trading Outcome 274 as measured by Applicant Group Members being agreeable to paying a monthly subscription to trade the Applicant's Multi-Faceted Trading Education System. If the outcomes were typical, a participant is typically barely sustaining themselves in the market. They may be winning here and there and losing about the same here and there. It is commonly recognized by persons of ordinary skill in the art of trading that a typical winning rate in the markets is about 65%. A win rate that is barely better than a guess and keeps the typical participant about even in wins and losses by the time there is consideration of their lack of confidence to do more for better results, considering trading costs, and so on. Validation that the Applicant's system produces an Improved Trading Outcome 284 is manifest by participants being willing to pay an access expense of a few hundred-dollar monthly subscription, then there would be no participation as the cost of the system would not be justified by marginal trade results. Given Improved Trading Outcomes 284, such Applicant Multi-Faceted Trading Education System is justified from month to month.

FIG. 2 critically discloses the further ability to create a Proprietary Trading Outcome 294 for financial market success beyond Improved Trading Outcomes 284 and Typical Trading Outcomes 274. It has been recognized that technology, tools, techniques, and tips abound in the financial markets with generally universal mediocre financial market success. This important element is the deliberate development of a Proprietary Trade Temperament 292. This is deliberately developed with from a combination of Proprietary Trade Signal Algorithms 220 passed through a Centralized Manipulated Market Data 250 provider for Proprietary Local Graphical and Numeric Trade Tools 254 combined with Proprietary Trading Education 230 to create a Proprietary Trading Technique 256 that provides uniquely effecting trading tools and techniques. These Proprietary Trading Tools 254 and Proprietary Trading Techniques 256 are uniquely effective in the financial markets and create an Improved Trading Outcome 284. However, given the associated burdens of entering the market, especially as a new and inexperienced trader, a Self-Funded Account 280 carries with it many expected and unexpected trading behaviors and emotions often interfering with optimal financial market success. The minimizing of just such expected and unexpected trading behaviors and emotions occurs by having the Student and group member trade a Proprietary Real money Educational fund 290. By not trading a Self-Funded Account 280, many associated trading behaviors and emotions are not present or present to the degree when trading one's own money in the market where there is a direct attachment. Trading the Proprietary Real Money Educational Fund 290 the real money is detached from the Student or group member and has a behavior and feel in the market like trading a practice account. The result is that students and group members under the direction of coaching, training, and mentoring or through their own financial market participation have the more neutral trade experience to deliberately develop more appropriate trade psychology habits and practices. This development comes from taking specific coach, trainer, or mentor trade guidance or making specific personal trading actions and experimentation or simply better practice coming from simply participating in the market with less emotional attachment to the account and market outcomes. This does not imply a recklessness or indifference to market outcomes, but minimizes involuntary behavioral and emotional characteristics and temperament that arises unknowingly, unexpectantly that occurs with trading the market when market trade funds have more meaning and attachment to the Student or group member. The result is a Proprietary Trade Temperament 292 that results in a Proprietary Trading Outcome 294 which is a more optimal and greater financial market trading result than the Improved Trading Outcome 284 and Typical Trading Outcome 274.

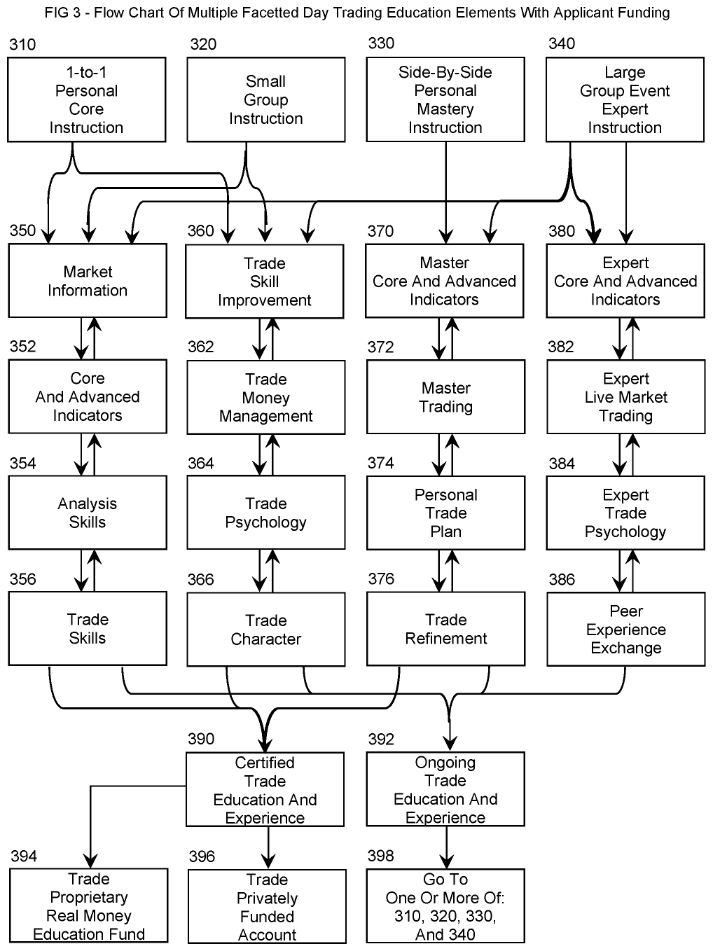

FIG. 3 is the Flow Chart Of Multi-Faceted Trading Education Forums And type Of Topics.

FIG. 3 discloses the multi-faceted nature of the Applicant's trading system encompassed in the Proprietary Trading Education FIG. 2 230. FIG. 3 more expressly defines the Proprietary Trading Techniques FIG. 2 256 which is the unique resulting combination of typical Local Market Price Candlestick Display FIG. 2 252 with Local Graphical and Numeric Proprietary Signals FIG. 2 254 and made effective by Proprietary Trading Education FIG. 2 230 to produce Improved Trading Outcome FIG. 2 284 beyond the Typical Trading Outcomes FIG. 2 274. The assimilation of the Applicant's disclosed proprietary trading system with the financial markets is observed with the Diagram Of Financial Markets And Multi-Faceted Trading Education Integration FIG. 1 and in process form with the Flow Chart Of Multi-Faceted Trading Education System FIG. 2. The result is a student or new day trader having the capacity to trade in the financial markets with Improved Trading Outcomes FIG. 2 284. In addition to what has been disclosed, The Applicant's trading system is expressly multi-facetted by trading education forums and type of topics. Disclosed is an extensive array of educational and experiential elements from 1-to-1 Personal Core Instruction 310, Small Group Instruction 320, Side-by-Side Advanced Instruction 330, and Large Group Event Instruction 340. The inter-related and combined experience providing the Student with multiple avenues of education by topic; multiple avenues of education by perspective with more than one and typically numerous different coaches, trainers, and mentors; multiple avenues of format from personal online and onsite, small group online and onsite, large group online and onsite, open chat forums, other forums a person of ordinary skill in the art would deduce from this Multi-Faceted Trading Education Forums And Type Of Topics FIG. 3. An important element of the Applicants Multi-Faceted Trading Education is that elements of the process are inter-related and a prospect, student, member, coach, and any participant may move from one element to the other within the associated elements. Created is a dynamic trade education and experience system that allows a participant to gain awareness of the whole of the system where needed, a specific element of the system and process, or focus on any one or more of the systems elements and process as is individually needed and desired. This dynamic and multi-faceted educational and experiential process is what creates the Improved Trade Outcomes FIG. 2 284 and an innovative spark of this disclosure.

FIG. 3 discloses the use of 1-to-1 Personal Core Instruction seen to encompass trade education and trade experience elements. Market Information 350 is also included as knowing the different markets, what typically influences them, where to find information about those influences, how to anticipate the reaction of the market based on known influences, knowing the pace of the market, understanding the cyclical nature of the pricing, and other market awareness known and used by trader of ordinary skill in the art of trading. Initial and continued development of Core Indicators 352 includes awareness of general or Applicant's proprietary indicators, their components, how to use them, how to interpret them, and how to apply them for improved trading outcomes. Trading Skills 356 is the education that assembles knowledge gained and relates it to the trade placement.

FIG. 3 discloses further advantages of the Multi-Faceted Trading Education system and process of the Applicant. What follows from a formalized education and experiential curriculum are an internalization of the trade process to begin to recognize trading as one's own or coming from oneself and not simply information and mechanics being more stepwise executed. Those attributes begin to emerge with Trading Skill Improvement 360. This emerges with practice and live trading over time and with reiterative education, coaching, and introspection by the trader about their trading. More education follows on advanced subjects of proper Trade Money Management 362. Not only is knowing the current fundamental character of the market, knowing how to analyze market data assess the current technical character of the market for potential trades, and then placing trades in the market, such trades must be applied with proper money management from trade entry to trade exit. This can include proper trade size, number of trades, projected distance the market will move, recovery methods for trades that may go against the trade setup, and more. Many of ordinary skill in the art would assert that money management or trade management may be some of the most important considerations of trade success. As such, the Applicant amply includes such information and training into the Multi-Faceted Trading Education process. A topic in the Applicant's trade curriculum, but difficult to instill, except through live market experience is that of Trade Psychology 364. This represents the necessity of proper trading attributes of the trader to participate in the market. This would be personal attributes such as patience for a better trade opportunity to present itself, rather than accepting a less than favorable trade simply because the trader is impatient, pressed for time, is eager to trade or place multiple trades, and so on. It represents the trader's ability to be disciplined to follow proven or establish general or personal trade plans and protocols that have been tested and proven successful generally or for the particular trader. It is disciplined to trade for a certain number of trades, a certain number amount of movement in the market, a certain amount of time, a certain amount of profit, and so forth and then be done with trading. Finish trading before fatigue, greed, poor discipline, and other failures in trade psychology begin to emerge with time in the market. As with Trade Money Management 362, Trade Psychology 364 can be considered some of the most important contributors to a successful trade routine. Also included in the Applicant's system and process is Trade Character 366 considerations. These would be considerations as to how the trade is developing or the appropriateness of the presented market behavior to place a trade. Not every market behaves the same. Not every asset or instrument within the same market behaves the same. Not every trade setup on an asset or instrument behaves the same, and so on. To address the additional variability of trading knowledge of Trade Character 366 is paramount. The Applicant's system and process addresses this important consideration on topics herein just mentioned, among others known to persons of ordinary skill in the art to again create the Improved Trading Outcomes FIG. 2 284 of which is specifically sought and designed. The result of the 1-to-1 Personal Core Instruction 310 is the Student gaining or completing a Certified Trading Education And Experience 390 that leads to a Real Money Funded Account 594, which is the primary purpose of the Applicants Multi-Faceted Trading Education process. Another outcome of the 1-to-1 Personal Core Instruction 310 contribution is continued or Ongoing Trade Education And Experience 392 by simply returning to 1-to-1 Personal Core Instruction 310, more Small Group Instruction 320, higher level instruction with Side-By-Side Personal mastery Instruction 330 and Large Group Expert Event Instruction 340. Actually, ordinary people skilled in the art would recognize that continued and deliberate education and experience training should not end but always be a part of successful financial market trade participation.

FIG. 3 discloses that the educationally based elements numbered 350 to 356 and experientially based elements numbered 360 to 366 just discussed are introduced by 1-to-1 Personal Core Instruction 310. These same just immediately presented educationally based elements numbered 350 to 356 and experientially based elements numbered 360 to 366 are further reinforced by Small Group Instruction 320. As disclosed previously the small group provides additional insight in the same subject matter, but often with a new or different perspective to the Student given the subject is likely to be presented by a different coach, trainer, or mentor. Given the different instructor or presenter, there may even be some new information imparted on topics already discussed with the Student at a basic and advanced manner. Further, the small group dynamic allows for students to gain insight and perspective from the interaction of other students with instructors and other students. The Small Group Instruction 320 provide valued breadth to information and application of trading education and experience. As with the 1-to-1 Personal Core Instruction 310, the Small Group Instruction 320 ultimately results in the Student progressing through or completing the Certified Trading Education And Experience 390 and beginning to a Trade Proprietary Real Money Education Fund 394 that provides a uniquely educational experience for developing overall collaborative trading skill and trading psychology. This Trade Proprietary Real Money education Fund 394 better prepares students and group members for their own Trade Privately Funded Account 396, although they may choose to use their own Trade Privately Funded Account 396 as their first trade account. The outcome of the Small Group Instruction 320 can also be to simply continue with additional instruction and exposure as summarized with step 398 or Go to One Or More Of; 310, 320, 330, and 340.

FIG. 3 continues to disclose the Multi-Faceted Trading Education Forums And Type Of Topics incorporates Side-By-Side Personal Mastery Instruction 330. That which has been disclosed herein to this point can be instruction given online or onsite. The majority of the instruction being given online. It would be undisputed that for subject mastery having the Student and the coach, trainer, or mentor together personally would have many advantages. As such, the Applicant's system and process includes educational and experiential components given in person. Not just 1-to-1 personal, but side-by-side and personally. Note that personally may not mean only one student with one coach, trainer, or mentor although that is often the case. It absolutely means no more than a handful so as to retain a personal awareness of the coach, trainer, or mentor to the Student. Undoubtedly more than one student could constitute a small group, but small group is referred to as more than a handful but when the personal connection of the coach, trainer, or mentor is largely disconnected. Nevertheless, in at this time the Side-by-Side Personal Mastery Instruction has a focused curriculum. Including Master Core And Advanced Indicators 370. The Applicant has a suite of proprietary indicators derived from associated proprietary algorithms to manipulate financial market data. Here the Student is taken beyond basic indicators and advanced training on all the indicators, but is provided instructional education and applied experience of general or the Applicant's proprietary indicators at a level of mastery. Mastery meaning further insight into the interaction of the indicators with financial market data, mastery with the indicators themselves, mastery with interpretation of the indicators to anticipate market behavior, and more. Mastery includes fluency and fluidity with the indicators such that the Student is beyond laboring over mechanics of application and into having the indicators become a useful tool. This manifests itself in Master Trading 372 that is demonstrated by Improved Trading Outcomes FIG. 2 284, as previously defined. Given the additional time and in-person nature of the Side-By-Side Personal Mastery Instruction 330, a benefit is the development of a Personal Trade Plan 374. This elevates the Student's confidence and success in the market knowing their instruction includes the specific tailoring of the Applicant's Multi-Faceted Trading Education system and process to them personally. That means adapted to their level of tolerance for market risk, their need for market gain or modulating their sense of greed in the market, the time they have, the hours of the day or week they have to trade, the frequency they like to trade, the number of trades at one time they seem to prefer or that is wise for the account, as well as dialing in money management, and other such topics as included in the Applicant's educational and experiential process. A student before this point is adapting their trading based upon the Applicant's educational and experiential system and process, but such evolution is less deliberate and finely refined as is available with master Side-By-Side Personal Mastery Instruction 330. Ultimately, the Student expresses an increased trading skill and capacity through Trade Refinement 376, again for Improved Trading Outcomes FIG. 2 284 as previously elaborated. As with other facets of the Applicant's trading education the Side-By-Side Personal Mastery Instruction 330 culminates with the Student more confidently progressing through or completing their Certified Trading Education And Experience 390 leading to trading a Trade Proprietary Real Money Education Fund 394. Ultimate success of the Applicant's multi-faceted trading education and funding process is the Student having the success and associated confidence to trade a Trade Privately Funded Account 396. The Student and group members may also Additionally, a student of this level of involvement and mastery will expectedly also participate in Ongoing Trade Education And Experience 392 in a variety of ways to include elements 398 of Going To One Or More Of: 310, 320, 330, and 340 of the Applicants educational process and system. Persons of ordinary skill in the art, and especially those of mastery realize the importance of continued trade skill and capacity development.

FIG. 3 additionally discloses the Applicant's Multi-Faceted Trading Education Forums And Type Of Topics includes Large Group Expert Event Instruction 340. Observed is that the breadth of the Large Group Expert Event Instruction 340 could incorporate and address all and any aspect of the Applicant's Multi-Faceted Trading Education system and process. Large group events are those that go beyond a small group event. A small group event is at a participant number where the coach, trainer, presenter, or mentor is not dealing on a personal level with The Participants, but is aware of and can acknowledge individuals. These can be online or onsite events. The large group events are those that have the coach, trainer, presenter, or mentor speaking generally to a crowd. Individuals are engaged, but there is not an intent to know or retain a recognition of an individual. These large group events provide for an expert instructional environment as the Applicant can draw from its best resources in instructional talent, topic, timing, and so forth to have the greatest instructional impact. Often this instruction is more lecture oriented with oral and visual components, but it is not intended that the Student or member follow along with their analysis software and trades at that moment. However, many students and members do bring devices to the large group events online or onsite and do meticulously follow the instruction at the moment. Of course, this is to their advantage. The Large Group Expert Event Instruction 340 allows all students and members access to the best instruction and elements at the moment of the Applicant's trading educational system and process and adds greatly to the expertise of The Participants. If a student or member of The Group needs reinforcement of a Large Group Expert Event Instruction, they are always able to cycle back through any layer of the Applicant's Multiple Layer Trading Education process to gain the clarity and applied skill ability they seek. Often the Students and members participating in the Large Group Expert Event Instruction are already participating in the market with a practice and even a real money account and so they often readily recognize the expert topics and elements of those topics based on their own growing trade experience. The subjects are not limited, but can include Expert Core And Advanced Indicators 380 from the Applicant's top coaches, trainers, mentors, and even more experienced members for the most effective and expert instruction. Expert Live Market trading 384 from the Applicant's pool of most successful live market traders to impart their insight, techniques, and tips for expert market outcomes. These may be the Applicant's coaches, trainers, mentors, or even more experienced members. Expert Trade Psychology 386 refers to the steadiness by which a student or member interacts with the market to avoid trading errors brought about by emotion, greed, impatience, poor trade management, inconsistency, and other such personal aspects of trading. Inclusive of some of the most important aspects of live financial market trading, addressing trade psychology with system and Applicant experts is a critical element to profitable trade success. That expertise is achieved, by the Applicant drawing on The Group's best coaches, trainers, mentors, and members that demonstrate expert trading based upon their knowledge and mastery of applying personal psychology to successful trading. Without Large Group Expert Event Instruction 340, a presentation from such experts may not otherwise be available to the entire student and membership. As with the chat application and smaller group forums that allow for student interaction, the Peer Experience Exchange 386 in the Large Group Expert Event Instruction 340 provides an expanded and refined interaction. Here students and members benefit from interaction with the most experienced and most successful group members. Given that interaction is with the Applicant's most expert coaches, trainers, and mentors, as well as most seasoned and successful members this forum provides students and other members access to rare expertise based on education and experience. The combination of elements of the Large Group Expert Event Instruction 340 clearly contribute to Improved Trading Outcomes FIG. 2 284 specifically designed and innovated by the Applicant's Multi-Faceted Trading Education of this disclosure. Like other aspects of the Applicants system and process the outcomes are more confident day traders continuing or completing Certified Trading Education And Experience 390 leading to or continuing with a Trade Proprietary Real Money Education Fund 394. The ultimate goal is the Student confidently and successfully trading their Trade Privately Funded Account 396 and FIG. 2 284. As discussed throughout, the learning, education, and expanded experience does not end with successful day traders and those seeking success. As such and again, another outcome of the Large Group Expert Event Instruction is to additionally provide Ongoing Trade Education And Experience 392 by returning to any and all available topics as suggested by 398 Go To One Or More Of: 310, 320, 330, and 340. The result of the Applicant's Multi-Faceted Trading Education Forum And Type Of Topics FIG. 3 is an Improved Trading Outcome of FIG. 2 284 as previously define.

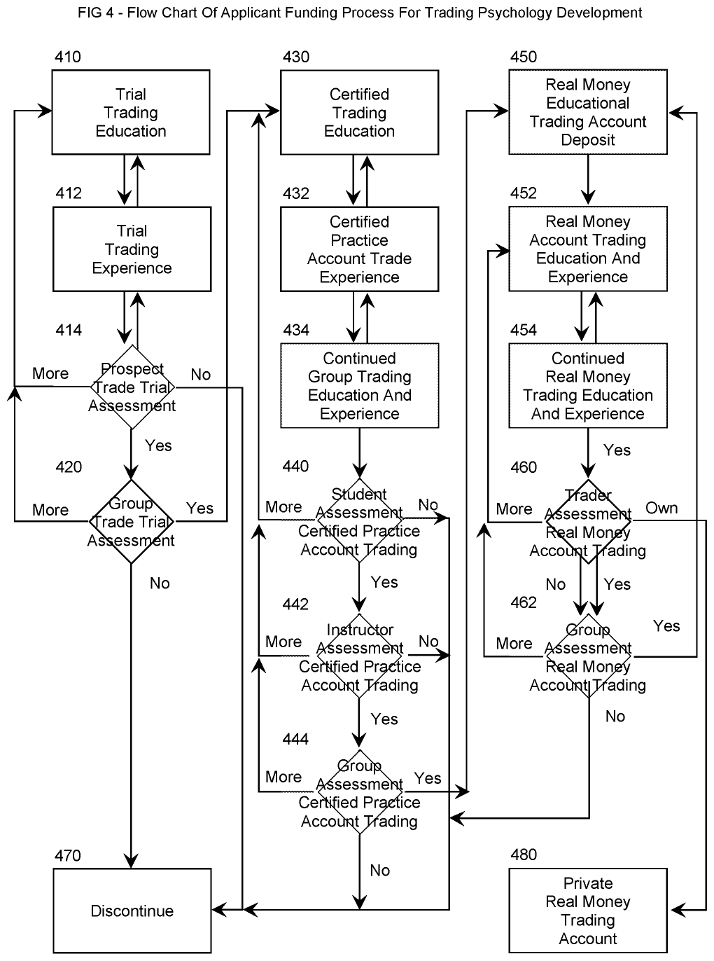

FIG. 4 is the Flow Chart Of Applicant funding Process for trading Psychology Development.

FIG. 4 discloses a multi-faceted trading education process that starts with the assessment of trading fit with a prospect through a Trial Trading Education 410 experience. This is the process of brining a prospect with no financial market trading experience or someone with some or advanced experience to a common awareness of the Applicant's trading process through education and information disclosure. This is a process that may include oral, video, written, demonstration, online, peer chat and sharing, and other instructional formats. An extension of educational aspects of the Trading Trial Education 410 is the Trial Trading Experience 412 where The Prospect applies the trading education. The Prospect moves freely from the Trial Trading Education 410 to the Trial Trading Experience 412 and back as more education or more experience may be needed in their trial. The intent of the trial is to reach a point where of Prospect Trade Trial Assessment 414. That includes assessing the Trial Trading Education which includes its content and delivery, as well as the temperament of the Applicant from The Prospect's perspective to have the mutual compatibility to continue the needed relation for financial market success. It also includes assessment of the Trial Trading Experience 412. At this point the purpose is learning basic trade methods and practicing those methods. It is not to achieve trading skill or mastery, but simply to learn and apply a few trading basics to assess their own personal compatibility and interest in trading as well as preliminarily assess the Applicant's trading system. This is an assessment that the trading system presented by the Applicant works sufficiently for The Prospect that they can see with additional coaching, training, and mentoring that they could become more proficient and successful trading the financial markets using the Applicants trading system. During The Prospect Trading System 414 The Prospect may election More education or experience The Prospect cycles back through the Trial Trading Education 410 and the Trial Trading Experience 412 and enters another Prospect Trade Trial Assessment 414 when they chose. The Prospect may also decide from The Prospect Trade Trial Assessment 410 that they do not wish to continue with a No assessment and then Discontinue 470 the Applicant's trading trial. The Prospect Trade Trial Assessment 414 may result in The Prospect determining, Yes, they see the potential of the Applicant's trading system and sense a compatibility of them with the Applicant to continue forward. At this point the Applicant's Group Trade Trial Assessment 420 follows. The Applicant Group being those designated to assess The Prospect's capability and compatibility with the Applicant and the Applicant's trading system. More, represents a Group Trade Trial Assessment 420 that The Prospect may be interested and agreeable to continue with the Applicant, but that the Applicant believes The Prospect needs further trial education and education. As such The Prospect then cycles back through the Trial Trading Education 410 and the Trial Trading Experience 412. An important element of the Applicants multi-faceted trading education and funding process is the mutual agreement that the Applicant's system and process are compatible with The Prospect. This may ultimately result in The Group Trade Trial Assessment 420 determining that, No, The Prospect is not prepared, compatible, sufficiently interested, or other such judgement to allow The Prospect to continue. Either The Prospect or the Applicant Group may determine this outcome. This Group Trade Trial Assessment 420 may result in a, Yes, determination that it is appropriate for The Prospect to continue to the Applicant's Certified Trading Education 430 and Certified Practice Account Trade Experience 432.

FIG. 4 discloses a formal Certified Trading Education 430 that provides advanced curriculum-based day trading information exchange and knowledge containing matter as disclosed in FIG. 3. As The Prospect, now a student in the formal Certified Trading Education 430 has had some introductory trading education and experience, the curriculum-based information and knowledge received is immediately applicable to Certified Practice Account Trade Experience 432. The Student moves seamlessly between Certified Trading Education 430 and Certified Practice Account Trade Experience 432 as part of their certified trade education and experience. This personal trading education and experience is interwoven with Continued Group Trading Education And Experience 434 as disclosed in FIG. 3 to add depth broader content and context to their trading. The purpose of trading education combined with real market experience using a practice account is to prepare the Student for entry and participation in the financial markets using real money. Trading education and practice trading are foundational elements to that ultimate objective. The best way to enter the financial markets is to determine readiness by the individual's perspective and the perspective of others. In this case, key contributions to the disclosure of the Applicant is the trading assessments by the Student, the Student's instructor or as has been referred to as a coach, trainer, or mentor; as well as by the greater organization or the entity that will be providing the real money trade fund. The Student Assessment of Certified Practice Account Trading 440 is made by the Student. This is done by assessing applied performance or actual participation in the financial markets using a practice account over a sustained period of time. This is an account specifically established to show participation in the financial markets with the same type of trading or use of technology, tools, techniques, and tips, as well as the same type of trade psychology or consistency, discipline, patience, and account management as would be used with a real money trading account. The Student may realize after a full trading educational curriculum and a period of time trading the financial markets with a practice account that they are not interested in trading, feel they are not adept at trading, or other reasoning and may choose that “No” they should not continue to trade in the financial markets and the Student would then Discontinue 470 their participation. The Student makes the first assessment and may determine “More” personal trading education, more personal trade experience, or more group trading education and experience is needed before they enter the financial markets trading real money. This would have them cycle back through one or more of the elements of Certified Trading Education 430, Certified Practice Account Trading Experience 432, or Continued Group Trading Education And Experience 434. The Student then cycles through more personal or group trading education and experience while continuing to determine their readiness for participating in the financial markets with real money. At some point the Student makes a “No” decision or expectantly may also experience the success in the financial markets that has them confident to continue with a “Yes” determination. Upon the Student deciding to go forward with real money financial market participation, the Student's instructor also makes a determination as to the Student's readiness with the Instructor Assessment Certified Practice Account Trading 442. The instructor may determine from their interactions and observations of the Student that “No” they are not compatible with trading the financial markets, that they have not devoted the needed time and effort to warrant trading the markets with real money, or other of many reasons for such a determination. The Student would then be Discontinued 470 from further participation with the Applicant. The instructor may also assess that the Student needs “More” time cycling through one or more of the Certified Trading Education 430, the Certified Practice Account Trading Experience 432, or Continued Group Trading Education And Experience 434. The Student then simply cycles through these trade education and trade experience elements with assessments occurring as appropriate. At the time the Student in the Student Assessment of Certified Practice Account Trading 440 determines “Yes” they are ready to trade real money in the financial markets and the instructor with the Instructor Assessment of Certified Practice Account Trading 442 also determines that “Yes” the Student is ready to trade real money in the financial markets does the Student progress to The Group Assessment of Certified Practice Account Trading 444. The Applicant Group then assesses the Student's readiness for real money trading participation in the financial markets. Like others, The Group may assess a “No” that the Student as not suitable for trading their money and may result in Discontinue 470 of the Student. The Group may assess the Student needs “More” trade education or trade experience, or both. Again, if this is the case then the Student is cycled back through one or more of the Certified Trading Education 430, the Certified Practice Account Trading Experience 432, or Continued Group Trading Education And Experience 434. The Student cycles through until the Student Assessment of Certified Practice Account Trading 440, the Instructor Assessment of Certified Practice Account Trading 442, and The Group Assessment of Certified Practice Account Trading 444 all judge “Yes” that the Student is ready to trade real money in the financial markets at which time they are funded with a Real Money Educational Trade Account Deposit 450.

FIG. 4 now discloses a key element in the trading psychology development and that is trading the financial markets with real money. Upon completion of the Certified Trading Education 430 and the Certified Practice Account Trading Experience 432 while participating in Continued Group Trading Education And Experience 434 the Student is then assessed for their readiness for real money trading in the live financial market. This assessment has been reviewed to include the Student Assessment of Certified Practice Account Trading 440, the Instructor Assessment of Certified Practice Account Trading, and The Group Assessment of Certified Practice Account Trading 444. Upon completion of the trade education and trade experience and an affirmative assessment by the Student, instructor, and group the Applicant creates a real money funded account as designated by Real Money Educational Trade Account Deposit 450. The Student then begins Real Money Account Trading Education And Experience 452 with Continued Real Money Trading Education And Experience 454. Essentially the Student begins trading the financial markets with the same trading information, knowledge, skill, and methods they were using in their Certified Practice Account Trading Experience 432. The significance of the Real Money Educational Trade Account Deposit by the Applicant is many fold, but summarized into two primary observations and objectives. The first is simply the Applicant's multi-faceted trading education and funding process has a person new or previously experienced now using a process for trading in the financial markets with real money that shows capacity for a Proprietary Trading Outcome FIG. 2 294 that is beyond the Typical Trading Outcome FIG. 2 274 and an Improved Trading Outcome FIG. 2 284. The Improved Trading Outcome FIG. 2 294 is due in noteworthy measure to the second primary contribution of the Real Money Educational Trade Account Deposit 450. This contribution lies in the ability of the Student to begin trading the financial markets with real money to which they are less emotionally attached. When new and even many under-developed experienced traders participate in the financial markets with their own money there can be an overwhelming emotional reaction. This is understandable as many may not be trading with what should be truly discretionary funds, they attach effort to their money, and many other reasons such that any losses or gains are attached to a host of individualized emotional responses and behavior. Again, an emotional response based upon the fear of losing their money, or greed to seek a greater return than is prudent for the money in the market, and many other individual responses. Often this heightened reaction to trading in the market leads to an increase in trading errors and mistakes. The key is the use another's real money, so it is less personally and emotionally attached to the Student and market participant trader. With less attachment to the money and any losses or gains in the market due to trading another source of real money in the market, the Student is less emotionally encumbered and more able to participate in the market based more on their Certified Trading Education 430, Certified Practice Account Trading Experience 432, and benefits of Continued Group Trading Education And Experience 434. The result is dramatically improved trading and sustainability in the market. This more education and skill development condition allow for the Student to not simply just trade the market, but actively develop trade psychology skill and temperament for the greatest financial market success.

FIG. 4 further discloses that a component of providing Real Money Educational Trade Account Deposit 450 is the addition of more trade money for further market trade profits and further market trade skill and trade psychology development. Trade skill and trade psychology can be directly related to the size of the trade account. The confidence or timidity of a trader in the market often varies as may be expected between trading for instance $1,000, $10,000, $100,000, and more. Such additional funding follows after a Trader Assessment of Real Money Account Trading 460. That is the Student may assess that “More” Real Money Account Trading Education And Experience 452 and interactively with Continued Real Money Trading Education And Experience 454 is needed. Under this circumstance, the Student will continue to trade their real money account and a practice account for additional trade experience and skill development. This cycle through additional trading education and trading experience with real money account and practice account further build the Student's trade psychology. For example, the Student may be trading well in the financial market, but may not feel they are ready for a larger real money trade account. More time with trade education and trade experience may be what they determine is needed for their preparation for a larger real money trade account. The Trader Assessment of Real Money Account Trading 460 may be assessed at any time or at time intervals as agreed with the Student and the Applicant's group. By way of the Student Assessment of Real Money Account Trading, the Student may assess that “Yes” they are ready for a deposit of additional real money into their real money trade account. At that time The Group assesses the Student's readiness for addition real money in their account. The Trader Assessment of Real Money Account Trading 460 can ultimately result in the Student determining they are ready to trade their own money with Private Real Money Trading Account 480. This is the result of the Student recognizing the application of their trading skill is producing sufficient results that they are confident enough to trade their own money. This also manifests a maturing trading psychology or a balanced temperament that has the Student recognizing their sufficient comfort in participating in the market with their own real money. As mentioned, with the Trader Assessment of Real Money Account Trading 460 resulting in a “Yes” determination is followed by The Group Assessment of Real Money Account Trading 462. In like manner of the “Yes” the Student may assess that they may not be further interested or “No” they are no longer interested in continuing. Like the “Yes” result, The Group would counsel with the Student to address any reasons they may be choosing not to continue. A remedy may simply be to have them do “More” Real Money Account Trading Education And Experience 452 and Continued Real Money Account Trading Education And Experience 454. The Group now has the requirement to assess the Student's readiness for additional funding in their real money trading account. The Group may assess that “More” Real Money Account Trading Educational And Experience 452 with Continued Real Money Trading Education And Experience 454 for the Student to further develop their trading skill with a real money account. The Group may also determine “More” is necessary from the Student to improve their trading psychology. The Group may also determine that both trading skill and trading psychology development may be necessary. In such cases the Student cycles back through Real Money Account Trading Education And Experience 452 and interactively with Continued Real Money Trading Education And Experience 454. At any time or at an agreed upon time the Student again makes a Trader Assessment of Real Money Account Trading 460 to see if they at that time sense they are ready for additional Applicant real money funding. There may be a time when the Student expresses they “No” longer which to continue to trade the markets. After assessment and discussion with the Applicant's Group, if the Student persists with their disinterest or The Group also determines it to be a prudent decision, then a “No” choice not to continue or Discontinue 470 trading in the financial markets with the Applicant's multi-faceted trading education and funding process. Upon completion of the Trader Assessment of Real Money Account Trading 460 The Group Assessment of Real Money Account Trading 462 as described herein. An assessment by The Group can be “Yes” the Student has demonstrated and is prepared for additional Real Money Educational Trade Account Deposit 450. The initial and additional real money deposits in the Applicant's funded trading account for the Student becomes a significant educational tool and vehicle in dramatically improving the Student's trading skill and associated trading psychology. The result from this cyclical trading skill and trading psychology development and refinement through Real Money Educational Trade Account Deposit 450, Real Money Account Trading Education And Experience 452, Continued Real Money Trading Education And Experience 454 followed by Trader Assessment of Real Money Account trading 460 and Group Assessment of Real Money Account trading 462 is the achievement of Proprietary Trading Outcomes FIG. 2 294.

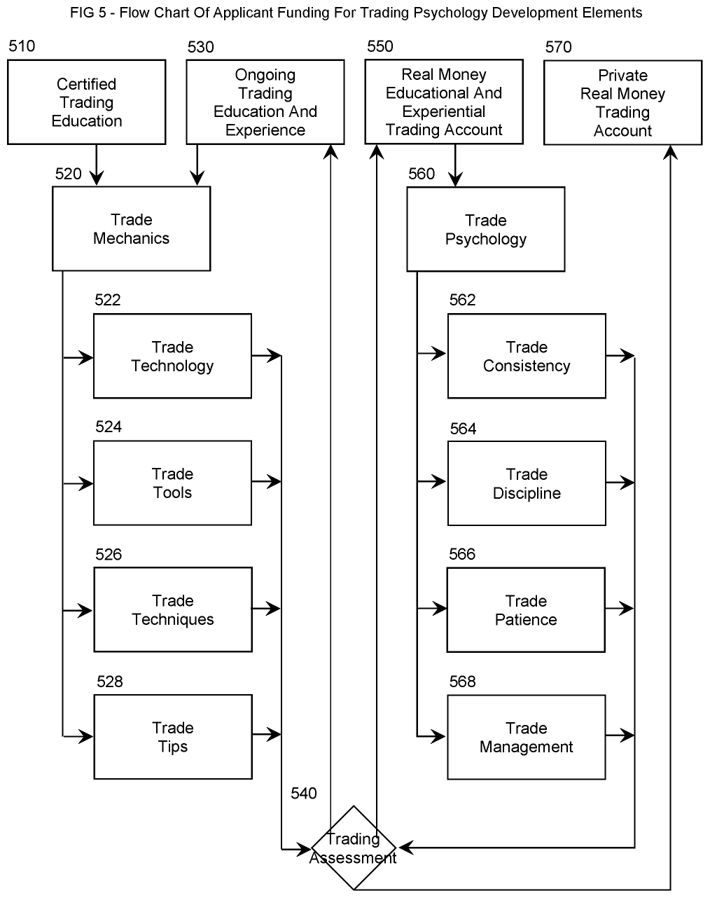

FIG. 5 is the Flow Chart Of Applicant funding for trading Psychology Development Elements.

FIG. 5 discloses the elements of trading skill development and trading psychology that create the Proprietary Trading Outcomes FIG. 2 294. The Applicant's multi-faceted trading education and funding system and process starts with Trade Mechanics 520 which represents aspects of trading that involves the physical infrastructure and the actions of participating in the financial markets. Shown this involves four broad areas of Technology 522, trading Tools 524, trading Techniques 526, and trading Tips 528 or the hardware, software, information, and skill associated with trading the financial markets. With regard to trading Technology 522 this involves The Prospect's, student's, member's or collectively The Participant's local interfacing device and connectivity into the connectivity and infrastructure of the financial markets as previously discussed herein with FIG. 2. The Participant needs sufficient device capability, connectivity, and awareness to interface with the markets. Some of this is simply general device operation, general internet connectivity, and general software protocol usage. Much of this is known by participants from general internet usage, but where there is specific processes and consideration, the Applicant's multi-faceted trading education and funding curriculum and association addresses. The trading Tool 524 is inclusive of general trading aids associated with the Brokerage Trade Platform FIG. 2 262 and include pricing as represented by candlestick patterns, commonly available technical indicators, line and geometric shape drawing, and other tools available to analyze, place, protect, and profit from trading participation in the financial markets. Trading Tools 524 also may include other trading tools that may not be commonly available or not available with the brokerage platform but may be used as separate information sources, indicators, analysis aids, and other support as may be available. One such source of additional trading Tools 524 are the Applicants Proprietary Trade Signal Algorithms FIG. 2 220 that result in Proprietary Local Graphical and Numeric Trading Tools FIG. 2 254. These include the Applicants mathematical algorithms that provide additional manipulation of External Streaming Market Input Data FIG. 2 210 to provide unique insight into past, present, and predictive market behavior. The Applicants Proprietary Local Graphical and Numeric Trading Tools FIG. 2 254 are one of the reasons for the Proprietary Trading Outcomes FIG. 2 294. Also included in Trade Mechanics 520 skill set are Techniques 526. This is inclusive of trading best practices as would be the habits and behaviors of traders having ordinary skill in the art of trading. These techniques also include specialized methods available from various unique sources throughout the financial trading industry and communities. Just such specialized techniques include those available through the Applicant's multi-faceted and Proprietary Trading Education FIG. 2 230 and as expanded upon in FIG. 3 and FIG. 4. Tips 528 includes going beyond the science or the technology, tools, and techniques and into the finesse and art of trading. This comes from experience. The Applicant provides just such finesse by incorporating more well-known tips and tricks in its curriculum. More such finesse is available from the spontaneous interaction of others in the Applicant's group as previously facilitated and discussed by the Small Group Instruction FIG. 3 320, Side-By-Side Personal Mastery Instruction FIG. 3 330, and the Large Group Event Expert Instruction FIG. 3 340. More specifically it has been disclosed that a student and member gain access to different coaches, trainers, and mentors with different context and perspective on the market. Further disclosed is that these aspects of the Applicant's multi-faceted trading education that students and members gain the insight of other more senior and more experienced members of The Group. As the Applicant supports the trading of numerous active participants in the markets trading the Applicant's real money trading accounts and many with their own private real money trading accounts creates vast active and current trading experience and learning. As the Applicant facilitates small group and large group interaction and exchange, the Student and other members have a tremendous learning environment to go beyond common best practices, go beyond the Applicant's 1-to-1 Personal Core Instruction FIG. 3 310 and early training Small Group Instruction FIG. 3 320 and into success facilitating tips and tricks from more experience instructors and members actively trading the markets. The result is an Improved Trading Outcomes FIG. 2 284 beyond Typical Trading Outcomes FIG. 2 274.

FIG. 5 further discloses the significance of cyclical exposure to the Applicant's multi-faceted trading education by disclosing again a consolidated Trading Assessment 540. This is a general representation of the various assessments as previously described in FIG. 4 and applicable to the trial and certified trading assessments. Within the appropriate aforementioned assessments and as represented here in the Trading Assessment 540, here the Student and group assess the Student's skill development and readiness for Real Money Educational And Experiential Trading Account 550. If the Student is not ready for Real Money Educational And Experiential Trading Account 550, then they return to Ongoing Trading Education And Experience 530. The Student simply cycles through the Applicant's multi-faceted trading education as previously detailed until the Trading Assessment 540 determines they are prepared for Real Money Educational Account Trading 550. As illustrated the Trading Assessment 540 may allow the Student and member to cycle through a form of Ongoing Trading Education And Experience at any time.

FIG. 5 discloses that at the point that the Trading Assessment 540 as detailed previously in FIG. 3 and FIG. 4 will result in the Student receiving Real Money Educational Trading Account Deposit FIG. 4 450 and in conjunction with Real Money Educational Account Trading FIG. 4 illustrated here within the Real Money Educational Account Trading 550. As previously disclosed in FIG. 4 and expanded upon in FIG. 5 the significance of the Real Money Educational And Experiential Trading Account 550 is actually participating in the financial markets for the potential of earning a financial gain and without the risk of personal loss. This occurs as the real money trade account is not funded by personal or private money associated with the Student or even member, but by the Applicant who is depending upon their multi-faceted trading education process as outlined herein to create market participation with general success leading to Proprietary Trading Outcomes FIG. 2 294. That Proprietary Trading Outcome FIG. 2 294 is the result of the Applicant's multi-faceted trading education and experience that has a significant contribution made by trading real money in the market. That differential made by trading real money as part of the educational process is Trade Psychology 560. Reviewed again it

FIG. 5 revels the key categories and importance of Trade Psychology 560 of trading. Learning the literal and figurative technology, tools, techniques, and tips is only part of what is needed to create success in the financial markets. These elements can be seen as machine-like elements. That is, the technology just works, the tools are predictive to one degree or another, the techniques have been shown to be useful and so forth, and of course some are higher performing than others, such as the Applicants Proprietary Trading Algorithms FIG. 2 220, Proprietary Local Graphical and Numeric Trading tools FIG. 2 254, and Proprietary trading Techniques FIG. 2 256. The machine-like nature of these elements is observed in that there are robotic trading systems that us objective parameters based on technology, tools, techniques, and tips to trade the financial markets. These systems tend to operate sufficiently for a period, but then require the intervention of human intelligence to recalibrate, adjusts, and tune them. Exemplified by the robotic example, but not a necessary example, it is known that trading the financial markets requires human intervention. However, as humans, particularly those less experienced, can be prone to the interference of their human nature. A nature that introduces emotion, preferences, stories about what the market is or how it behaves, reactions, forgetfulness, and other human characteristics that make trading and participating in the financial markets less predictable. This is expressly the purpose, discovery, and spark of inventiveness of the Applicant to have students trading a real money account that is minimally attached to the Student's expectations and emotions. The Student is left more emotionally and behaviorally free or in a more objective state to trade more systematically as taught through the Applicant's multi-faceted trading education. Given that the Student is more emotionally neutral and objective, they are also more available to learn from their experiences more realistically and without interfering interpretation. The result is a student gaining information, knowledge, and wisdom more quickly and factually from their real money financial market participation. Some trading psychology can be gained by instruction, but this is essentially an acknowledgement level of the existence and influence of one's personal preferences, proclivities, personality, and other individual traits can have on trading. Instruction around trading psychology really goes no further. Trading a practice account takes recognition of the impact of trading psychology on trading outcomes further, but it is often quickly observed that student's regularly behave with practice accounts in a way that demonstrates there is really nothing at sake. Real money trading is the catalyst that brings instructional principle into reality where the Student senses the impact of emotion and behavior on financial market trading. When this real money trading involves the Student's own money, the emotion and related behavior can be too strong and interfere with proper and wise trading methods and execution and cloud and misinterpret their behavior in the market as well as the market's behavior. The Applicant's process of having student's trade the Applicant's real money account serves to attach real market human experience to instructional principles without the overwhelming emotional interference. There does still remain a different trading emotion using the Applicant's real money, but it is minimized and tempered as to be less interfering. It is enough to elevate their growth in trading skill attached to the new realm of trading with trading psychology, but not so much emotional involvement as to mask implementation of more proper trading knowledge and skill and not so much as to interfere with proper interpretation of their behavior in trading and the markets. Additionally, the Trading psychology is internalized largely with experience. Under the Applicant's multi-faceted trading educational and experiential process of FIG. 3 and FIG. 4 accompanied by using the Applicant's Real Money Educational And Experiential Trading Account 550 the Student experiences surprisingly rapid and elevated refinement of trading psychology. A significant reason for this minimized real money trading emotional response is that there is not expectation placed upon the Student with the use of the real money trade account. This results as the money is not a loan, so the Student's do not have a sense of obligation around the money to pay it back and that market failure would add financial pressure upon their personal finances. Essentially the Applicant is taking all the monetary risk and the Student is free to trade the money as if it were simply a practice account. If the Student does have a catastrophic trading event and the account is closed or lost, again the Student is not obligated to repay the real money into the trading account. The money was provided as part of the Student's educational experience. Further, the Applicant has no expectation that the Student produces a certain type of market participation return. The Student is not given goals, quotas, objectives, or reports showing they should perform to one level or another. The Student is simply provided the Real Money Educational Trading Account Deposit FIG. 4 450 and allowed to trade the funds as they have trained with the Applicant's multi-faceted trading educational process and system. As such, the Student does not suffer from external artificial expectations and emotional burdens. The Student is left to trade the real money account in the markets seamlessly as they did with a practice account creating the most facile transition from practice trading to real money trading and participation in the financial markets. As a result of the Applicant's process around its Real Money educational Trading Account Deposit 450 and additional deposits the Student continues to develop their real money trading skill and continues to add layers of positive and productive trading psychology understanding, sensation, management, trading objectivity, and other proper and wise human involvement characteristics with the financial markets. The Applicant's student accelerates their trading skill and trading psychology in a way that would be more reminiscent to someone of years of refined training and experience in the market from a trading skill and trading psychology perspective. As such, cycling in and out of the market in combination with personal, small group, and larger group instruction the Student accelerates the layering of objective real money trading skill and trading psychology for a Proprietary Trading Outcomes FIG. 2 294 with is enhanced beyond an Improved Trading Outcomes FIG. 2 284 and further beyond Typical Trading Outcomes FIG. 274.

FIG. 5 specifically reveals four key elements that broadly capture many aspects of trading psychology. Consistency 562 refers to both the frequency of trading and repeatability of a proper trading outcome. The intention of participating in the financial markets is to earn a financial gain. If a participant is disinterested, nervous, fearful, not confident, and so forth then they will not consistently or regularly participation in the market. Lack of regular participation leads to stagnation in trading skill and trading psychology retention or development and lack of progress. It may also lead to the degradation of trading skill and trading psychology. In either case, what often follows is a lack of market success, the likely reinforcement of disinterest, concern, fear, and more lack of confidence. Ultimately, accounts fail and The Participant is out of the market. Needed to retain participants in the markets is enough consistency to have a growth or success trajectory. Initially the focus may be on recognizing regular improvement in trading skills and trading sensibility towards trading the markets. In time and with trading skill and trading psychology outcomes likely become more consistent resulting in more regular market gains with acceptable losses. Consistency in a multi-faceted trading success contributor generally and even specifically towards how a financial market participant approaches the market.

Discipline 564 is a contributor to regular or consistent market results. Predictable results occur from The Participant applying the same trading method to appropriate market conditions to achieve a predictable trading result. Where Consistency 562 is more of a focus on regularity of market participation, Discipline 564 is more of a focus on trading plan precision. The Applicant's multi-faceted trading education develops with the Student a trading plan specific to their personal preferences. By doing this, the Student more naturally approaches the market. This is a big contributor to reducing unnecessary emotion associated with trading. Many adaptations of trading methods work in trading the financial markets. The key is to determine the adaptations are successful in the market with the aid of Applicant's coaches, trainers, and mentors and then specifically discussed here is to have the discipline to follow that personalize trading method. The Student or a participant in the market may, and often, makes changes to their trading plan. That is fine and often necessary for a variety of reasons, but then trade a method adaptation after finding it to be successful practice trading with live streaming market data and then again, have the discipline to trade that proven adaptation. This is an important element of trading psychology as it is human nature to continually wish to modify a proven trading plan, or make an exception here and there when market conditions are not consistent with the proven trading plan, or to apply the trading plan prematurely given emotional exuberance, fear, greed, and other human reactions while at the moment in the market. There are many other driving forces that seek to fracture trading plan discipline. Trading the Applicant's real money in the market allows students to sense such emotions to participation in the markets under circumstances where they can experience the market, objectively learn from trading mishaps, and make trading decision less ladened by more unchecked emotional and human behavioral actions.

Patience 566 is similar to other trading psychology attributes in that they are interwoven and not distinctly segregated. Patience 566 can incorporate elements of Discipline 564 in aspects of being willing and able to wait for the proper market conditions to enter or exit a trade. Much that is associated with Discipline 564 can be associated with Patience 566. Patience 566 further includes The Participants outlook in working with the markets. Participants in the market need to take a patient longer-term perspective. It takes time to not only take in information and knowledge about the financial market trading but then to gain refining skill experience in the markets by participating in the markets. In addition, trading psychology is not simply understood as an event. It is developed overtime, built upon one experience followed by another. The neutral conditions of the Applicant's Real Money Educational Trading Account Deposit 450 accelerates this trading psychology development as the Student is freed of so many typical real money trading risks and concerns. The Applicant's students are further continued to be supported by personal and group education as described herein with FIG. 3 and FIG. 4. For Applicant student's they need to also have patience in cycling through assessments to receive a Real Money Educational Trading Account Deposit 450 as well as additional Real Money Educational Trading Account Deposits 450. The Student is rewarded in applying Consistency 562, Discipline 564, and Patience 566 as described herein as doing such accelerates positive assessment 540 and as described in FIG. 4 that leads to more regular Real Money Educational And Experiential Trading Account deposits 550 and as reflected in Real Money Educational Trading Account Deposits 450. Importantly, is that as the well known by traders of ordinary skill in the art of trading that a larger account allows for greater participation in the financial markets with greater potential for market gains. Patience is a human trait that often requires development and through the Applicant's multi-faceted trading education in combination with the Applicant real money account funding the Student is education and incentivized to exercise and practice patience. By doing so their development around patience is accelerated, refined, and solidified for a Proprietary Trading Outcome FIG. 2 294.

FIG. 5 discloses that Trade Psychology 560 includes the larger concept of Trade Management 568. Similarly integrated with other aspects of Trade Psychology 560, but encompasses decisions around trade parameters. For instance, based upon Trade Mechanics 520, the human element is then introduced adding subjectivity. The trader then makes decisions the trade direction, when to enter the trade, how much of the account to risk with the trade or the level of reward sought, how far to anticipate the market movement, when to exit the trade, how many trades to run at the same time and so on. Trading psychology involves trading within the appropriate parameters. For instance, one or two critical elements included within Trade Management 568 is the size of risk. The Applicant teaches a rule of thumb, but it is up to the Student to apply this proven trading principle. Some traders with a more risk adverse trade psychology must push aside their timidity or fear so as not to trade too little risk or reward so as they can experience more of the financial market potential. Other students with a more risk tolerant trade psychology need to pull back their greed and excitement and not over trade the account with unnecessary risk. Another important factor is placing an appropriate trade protection. Again, those with a more risk adverse trade psychology may set their trade protection too close leading to far more premature trade closures for a loss by not giving the market space to oscillate within its natural rhythm for the size of the trade and other conditions. Other students with a more risk tolerant trade psychology may set their trade protection too far out and again putting the account at too much risk. There are a number of mechanical aspects of trading that are influenced by the trade psychology of the Student and financial market participant. Most surprisingly is the transformation of information and knowledge from an educational and practice environment is internalized into market skill and wisdom through the neutral expectation of Real Money Educational And Experiential Trading Account 550. With time in the financial market with real money the Trading Assessment 540 as previously detailed in FIG. 3 and FIG. 4 is made. The Student my singly or simultaneously cycle through more Ongoing Trading education And Experience 530 with more Trade Mechanics 520 or continue trading their existing account or receive additional Real Money Educational And Experiential Trading Account 550 funding. The Student may also determine through the Trading Assessment 540 that they are prepared and interested in trading their own Private Real Money Trading Account 570 which is the ultimate goal. The ultimate objective of a trader in the financial markets trading their own funds with enhanced Proprietary Trading Outcomes FIG. 2 294.

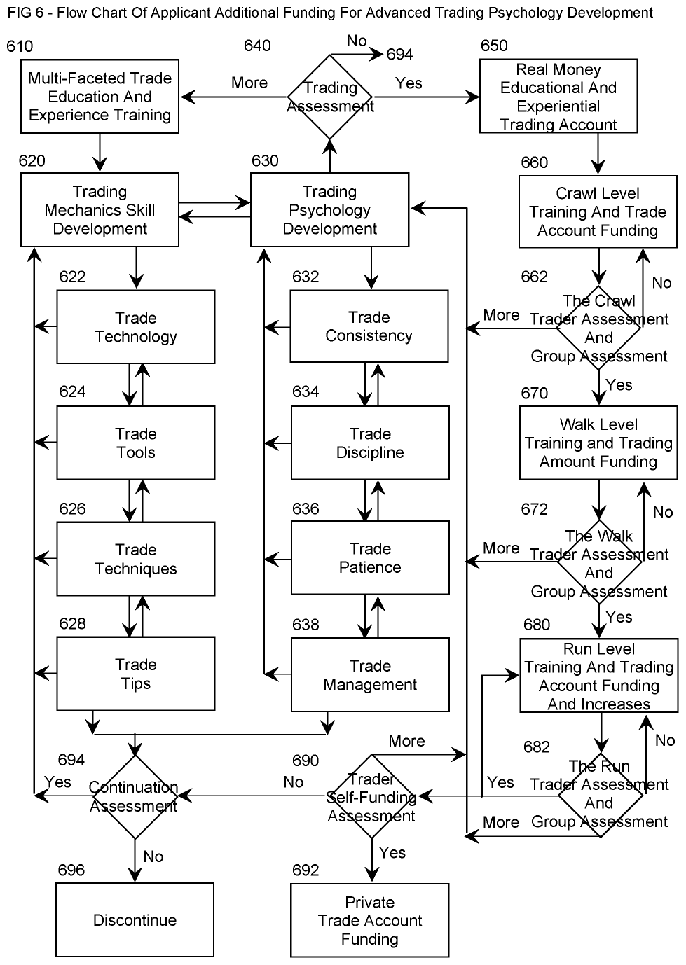

FIG. 6 is the Flow chart Of Applicant Additional funding for Advanced Trading Psychology Development.

FIG. 6 is the accumulated representation of the Applicant's Multi-Faceted Trading Education And Experience Training 610. Inclusive in this is FIG. 1 represents the position of the Applicant and associated multi-faceted trading education and funding elements in the large infrastructure of the financial markets. FIG. 2 is representative of the specific elements of the Applicant's multi-faceting trading education and funding based upon Proprietary Trading Signal Algorithms FIG. 2 220 resulting in Proprietary Local Graphical and Numeric Trading Tools FIG. 2 254 combined with Proprietary Trading education FIG. 2 230 for a cohesive Proprietary Trading Techniques FIG. 2 256 process further facilitated by Proprietary Real Money educational Funding FIG. 2 290 resulting in Proprietary Trading Outcomes FIG. 2 294. FIG. 3 highlights elements of the multi-faceted trading education to include 1-To-1 Personal Core Instruction FIG. 3 310, Small Group Instruction FIG. 3 320, Side-By-Side Personal mastery Instruction FIG. 3 330, and Large Group Event Expert Instruction FIG. 3 340 to create a Certified Trade Education And Experience FIG. 3 390 which is the same as the Proprietary Trading Techniques FIG. 2 256 of which results the Trade Proprietary Real Money Education Fund FIG. 3 394 or Proprietary Real Money Educational Fund FIG. 2 290 for the Proprietary Trading Outcomes FIG. 2 294. FIG. 4 discloses key elements to funding students in the Applicant's multi-faceted trading education. The Student moves from a Trial Trading Education 410 with practice trading experience through student and group assessments. The ideal outcome would have the Student progressing to the Certified Trading Education 430 with practice trading experience and through student, instructor, and group assessment concerning readiness of the Student for a real money trading account funded by the Applicant. The Student receives a Real Money Educational Trading Account Deposit 450 and begins trading with continued education followed by student and group assessments for additional funding. Ultimately the Student reaches a level of trading skill and trading psychology or confidence to trade their own privately funded account with continued Proprietary Trading Outcomes FIG. 2 294. FIG. 5 introduces that in addition to Trade Mechanics FIG. 5 520 and its broad category elements learned through the Applicant's multi-faceted trading education that another critical aspect of successful trading in the financial markets is the development of appropriate Trade Psychology FIG. 5 560 and its broad category elements. Increasing trading skill and trading psychology are achieved by cycling through Trade Mechanics FIG. 5 520 and Trade Psychology FIG. 5 520 with intermittent Trading Assessment 540 to determine a student's next refining course of action. Learned in FIG. 5 is the importance of trading psychology to the ultimate Proprietary Trading Outcomes FIG. 2 294 that can ideally lead to the ultimate success of an education process and that is an independently functioning student or now financial market participant with their Private Real Money Trading Account 570.

FIG. 6 discloses the refunding process of the Applicant's multi-faceted trading education and funding process that facilitates increasing development of trading skill, but most particularly a trading psychology that supports the greatest market participation. Trading Mechanics Skill Development 620 with its elements of Trade Technology 622, Trade Tools 624, Trade Techniques 626, and Trade Tips 628 have been previously detailed with FIG. 5 description, as well as described elsewhere herein. Also shown is the option to the Student and to The Group for a Continuation Assessment 694. The Student or The Group could assess that “Yes” the Student should continue and cycle back through the Applicant's processes or “No” the Student should not continue and move to Discontinue 696 their financial market trading. Trading Psychology Development 630 and its broad categorical elements of Trade consistency 632, Trade Discipline 634, Trade Patience 636 and Trade Management 638 have also been detailed in the FIG. 5 description and suffice for the disclosure here. Again, the Student and The Group have the opportunity for Continuation Assessment 694 throughout the Student's trading skills development, trading psychology development, and trading experience. The assessments may be “Yes” continue through the Applicant's processes or “No” the Student should Discontinue 696 trading the financial markets. In like manner the Trading Assessment 640 of the Student's knowledge, skills, and abilities is available and as have been previously detailed with FIG. 4 by Student Assessment of Certified Practice Account Trading 440, Instructor Assessment of Certified Practice Account Trading 442, and by Group Assessment of Certified Practice Account Trading 444. These assessments evaluate trading skill and trading psychology to the best they can before the Student begins trading real money and incorporates real money trading behavior. The Trading Assessment may identify that “More” Multi-Faceted Trade Education And Experience Training 610 is needed. The Student then cycles back through training as disclosed here in and represented by Trading Mechanics Skill Development 620 and Trading Psychology Development 630. At an arbitrary time, a set time or period, or at a performance achievement the Student is reassessed for real money deposit. An outcome of the Trading Assessment 640 may be a “No” determination that it would be best that the Student Discontinue 694 training and not trade a real money account. Ultimately, by way of assessment and through development stages a Trading Assessment 640 “Yes” determination is made and the Student is approved by the Applicant Group for Real Money Educational And Experiential Trading Account 650 or as previously represented as Real Money Educational And Experiential Trading Account FIG. 5 550 and FIG. 4 450, as well as Trade Proprietary Real Money Education Fund FIG. 3, 394.

FIG. 6 specifically discloses an Applicant real money educational funding process that is a crawl, walk, and run approach that coincides with the Student's trading skill and trading psychology development. Initial Real Money Educational And Experiential Trading Account 650 is a Crawl Amount Training Trade Account 660 or a beginner's get acquainted with the market account. This is a smaller account size that is less intimidating to the Student, yet large enough to meet financial market requirements and to produce some earnings with appropriate trading. This is simply a smaller starter account to give the Student initial access and experience with real money in the financial markets. This real money educational and experiential fund is supported by ongoing trade skills and trade psychology training as students access training as previously illustrated or as they may cycle through Trading Mechanics Skill Development 620 and Trading Psychology Development 630. The amount may vary based upon Instructor Assessment of Certified Practice Account trading FIG. 4 442 and Groups Assessment of certified Practice Account trading FIG. 4 444. The account is not necessarily funded to earn noteworthy profits, but as an educational vehicle to provide the Student with a real money financial market trading experience and related education. The trading skill applied to the account is that used with practice trading. The account continues trade skill development, but has a greater impact on trade psychology development which is present, but minimally developed with a practice account. Again, given the neutral expectation around the account and given that the funding is not from the Student, the Student is substantially freed of many of the emotions associated with trading a real money account in the financial markets. The result is a more successful first real money trading experience. The Student is able to apply their trading education more directly and objectively without the substantial interference of trade psychology. It would be accepted by traders of ordinary skill in the art of trading that any trade psychology present at the beginning of a participant's trading experience would have more of a negative impact on the account than a positive influence. As such, minimizing the impact of initial trade psychology on the account allows for a more neutral to successful or profitable or winning ratio experience in the account. As a result, the Student stays in the financial markets as a trader and gain more time in the markets, more exposure to the market, and more development of their trade psychology in the market from which they can develop for positive market outcomes. The Student is starting from a more neutral trade psychology position from which they can build positive trade psychology from their own experience and by cycling back through the guidance of coaching, training, and mentoring. At an arbitrary time, a designated time, or at a performance achievement milestone, the Student undergoes a Trader Assessment And Group Assessment 662 on their real money trading as also detailed Trader Assessment Real Money Account Trading FIG. 4 460 and Group Assessment real Money Account Trading 462. The result of trading a smaller transitional account is the initial development of the day trader beyond that available practice trading. There is continued trading mechanics skill development to included, but not limited to the ability to research, continually improve upon manipulating trading software, to better interpret indicator signals, to better interpret market behavior, and place more accurate trades. Trading Mechanics Skill Development 620 is referred to as containing Trade Technology 622, Trade Tools 624, Trade Techniques 626, and Trade Tips 628. The other aspects or results produced by trading a starter “crawl” real money account is the initiation of more realistic Trading Psychology Development 630. This can include the trader's emotional position with the market to include, but not limited to how they handle signals, their relationship with placing a trade, how they react with a trade in the market, do they need to watch the trade, can they leave a trade and let it continue without their presence, how they respond to losing conditions or a losing trade, their reaction to trade profits or losses, and the list could go on. Trading Psychology Development 630 has been referred to as including Trade Consistency 632 or how similarly trade signals are interpreted, how accurately trade conditions are identified, and how regularly do they trade. Another is Trade Discipline 634 to follow an established successful trade method. Trade Patience 636 or the increased ability to wait for well-established trades, wait for a more ideal trade entry moment, allow the trade to develop according to established methods, and exit the trade at a predetermined or at a market signaled moment. Trade Management 638 or establishing trade parameters that are rational for the skill level of the trader, the size of the account, the type of market being traded, the current market conditions being trades, use of trade protections, and other proper trade character and preservation. This results in the critical development of trade psychology or a stable, controlled, and healthy emotional relationship of the trader with the financial markets, their trade methods, the act of trading, how they respond to funded account size, and other elements of trading to create not only needed successful trading skill but a successful emotional relationship with all aspects of trading. Without both Trading Mechanics Skill Development 620 and Trading Psychology Development there really can be very little true trading success. The assessment may include the outcome that the “More” education is needed through the Multi-faceted Trading Education and Experience Training 610 which leads to more Trading Mechanics Skill Development 620, more Trading Psychology Development 630, or both. The Student then continues to trade their Applicant real money funded account while continuing to advance their trading skill and trading psychology. Through this action the Student or The Group may also determine that the Student should Discontinue 696 with further trading. At an appropriate time, the Trader Assessment And Group Assessment 662 reoccurs at which time another full assessment is completed. Another outcome of the Trader Assessment And Group Assessment 662 is a “No” that further funding will not occur at the time, but that more systematic effort in trading skill and trading psychology is not needed, the Student simply continues to trade the existing funded account and at an appropriate time enters a new Trader Assessment And Group Assessment 662. An outcome of the Trader Assessment And Group Assessment 662 is that “Yes” the Student is ready by trading skill, trading psychology, and trading performance for a real money deposit into their real money trading account to create a Walk Trade Training Account. Part of the educational process is that the Student retains between 50% to 90% of the funds gained in the account. This is an important aspect of the educational process in trading real money in the market is to also experience the rewards of profits or not receive a distribution and reconcile the result of losses in the market. This is another component of trading psychology development associated with Crawl Amount Training Trade Amount 660. Ultimately, the Student has advanced in their trading skills and mechanics and their trading psychology and outcomes.

FIG. 6 shows the Applicant's funding process includes a second funding of the Students Real Money Educational And Experiential Trading Account 650 due to the Student's demonstration of sufficient trading skill, trading psychology, and trading performance. In likeness of a child learning to gain mobility, there is a general process of crawl, walk, and run. In like manner, the first initial funding Crawl Amount Training trade Account 660 was smaller and more of a type of analogy of crawling as a real money market trader. The Walk Amount Training Trade Account 670 is a “walk” or moderate amount of real money account. It is the second addition of real money to the Student account or an account still associated with the Student finding and refining their trading skill rhythm and trading psychology sensibilities. This funding remains more of a smaller addition that adds tangibly to the account, but within the sense of an account size that remains less unintimidating to the developing trading skills and trading psychology of the Student. The Student begins trading the account for trading skill and trading psychology development. The Student now having weeks and months of training and weeks or months of trading is more balanced with less effort devoted to internalizing the mechanics of trading and transitioning into better integration of the mechanics of trading and the psychology of trading into a more integrated process, than isolated thought and action processes. The Student is arriving at their initial trading style and rhythm toward the financial markets. They have moved from the metaphorical “crawling” stage to the metaphorical “walking” stage of their financial market trading evolution. The Student at this time is often more focused on trading than training, but remain engaged in Trading Mechanics Skill Development 620 and Trading Psychology Development 630 through the various training venues incorporated in the Multi-faceted Trading Education And Experience training 610 that is detailed throughout this document as the Student may need or desire. The result of trading an intermediate or “walk” sized account is further Trading Mechanics Skill Development 620 and Trading Psychology Development 630. It is continued expansion of this development of the day trader beyond that available practice trading or trading a smaller real money account. There is continued trading mechanics skill development to included, but not limited to the ability to research, continually improve upon manipulating trading software, to better interpret indicator signals, to better interpret market behavior, and place more accurate trades. Trading Mechanics Skill Development 620 is referred to as containing Trade Technology 622, Trade Tools 624, Trade Techniques 626, and Trade Tips 628. The other aspects or results produced by trading an intermediate “walk” real money account is the initiation of more realistic Trading Psychology Development 630. This can include the trader's emotional position with the market to include, but not limited to how they handle signals, their relationship with placing a trade, how they react with a trade in the market, do they need to watch the trade, can they leave a trade and let it continue without their presence, how they respond to losing conditions or a losing trade, their reaction to trade profits or losses, and the list could go on. Trading Psychology Development 630 has been referred to as including Trade Consistency 632 or how similarly trade signals are interpreted, how accurately trade conditions are identified, and how regularly do they trade. Another is Trade Discipline 634 to follow an established successful trade method. Trade Patience 636 or the increased ability to wait for well-established trades, wait for a more ideal trade entry moment, allow the trade to develop according to established methods, and exit the trade at a predetermined or at a market signaled moment. Trade Management 638 or establishing trade parameters that are rational for the skill level of the trader, the size of the account, the type of market being traded, the current market conditions being trades, use of trade protections, and other proper trade character and preservation. This results in the critical development of trade psychology or a stable, controlled, and healthy emotional relationship of the trader with the financial markets, their trade methods, the act of trading, how they respond to funded account size, and other elements of trading to create not only needed successful trading skill but a successful emotional relationship with all aspects of trading. Without both Trading Mechanics Skill Development 620 and Trading Psychology Development there really can be very little true trading success. At an arbitrary time, a designated time, or at a performance achievement milestone the Student may be assessed for additional Applicant real money funding into their account. When appropriate the Trader Assessment And Group Assessment 672 after the “walk” or second real money funding, As with other assessments the Student and The Group individually and mutually assess the Student's readiness for additional Applicant real money funding. An outcome of the assessment can be that “More” Trading Mechanics skill Development 620, Trading Psychology Development 630, or both are needed. The Student would then cycle through more educational and experiential elements to strengthen these identified needs. Through this action the Student or The Group may perform a Continuation Assessment 694 and determine that the Student should “Yes” continue or “No” Discontinue 696 with further trading. The assessment may further identify a “No” or that additional funding will not be provided, but that the Student simply needs more trading time with the account at its current funding. The Student may also continue with on-going education as outlined herein. Another outcome of the Trader Assessment And Group Assessment 672 is that “Yes” the Student is ready for even greater “run” levels of real money funding with Run Amount Trading Account And Increases 680.

FIG. 6 illustrates a Run Amount Trading Account and Increases 680 where the Student receives additional Applicant real money deposit. The “crawl” and “walk” real money amounts are very distinctly designed for new experience with real money in the financial markets. The “run” amount and subsequent increases is designed to continue the Student's education particularly in the realm of trading psychology with increased account amounts. The mechanics of trading and how the Student applied those mechanics to the financial markets may change little at this point, but their growth and adaptation in the area of trading psychology may change, evolve, and influence the outcome of the Student's trading more significantly. Part of the significance towards trading psychology is that the “run” level Applicant real money deposits can be larger. Again, the Student trades the Run Amount Trading Account And Increases 680 for an arbitrary period of time, a specific period of time, or upon achievement of a specific outcome and then the Student and now often seen as a member trader undergoes Trader Assessment And Group Assessment 682. The Applicant now sees the trader as a group member as they have weeks and months of real money trading in the financial markets and have demonstrated an ability to successful trade the markets with a Proprietary Trading Outcome FIG. 2 294. The result of trading a larger “run” level full real money trade account is the more complete development of the day trader beyond that available practice trading and smaller funded account levels. There is continued trading mechanics skill development to included, but not limited to the ability to research, continually improve upon manipulating trading software, to better interpret indicator signals, to better interpret market behavior, and place more accurate trades. Trading Mechanics Skill Development 620 is referred to as containing Trade Technology 622, Trade Tools 624, Trade Techniques 626, and Trade Tips 628. The other aspects or results produced by trading a larger “run” real money account is the more mature and realistic Trading Psychology Development 630. This can include more fully developed traders emotional position with the market to include, but not limited to how they handle signals, their relationship with placing a trade, how they react with a trade in the market, do they need to watch the trade, can they leave a trade and let it continue without their presence, how they respond to losing conditions or a losing trade, their reaction to trade profits or losses, and the list could go on. Trading Psychology Development 630 has been referred to as including Trade Consistency 632 or how similarly trade signals are interpreted, how accurately trade conditions are identified, and how regularly do they trade. Another is Trade Discipline 634 to follow an established successful trade method. Trade Patience 636 or the increased ability to wait for well-established trades, wait for a more ideal trade entry moment, allow the trade to develop according to established methods, and exit the trade at a predetermined or at a market signaled moment. Trade Management 638 or establishing trade parameters that are rational for the skill level of the trader, the size of the account, the type of market being traded, the current market conditions being trades, use of trade protections, and other proper trade character and preservation. This results in the critical development of trade psychology or a stable, controlled, and healthy emotional relationship of the trader with the financial markets, their trade methods, the act of trading, how they respond to funded account size, and other elements of trading to create not only needed successful trading skill but a successful emotional relationship with all aspects of trading. Without both Trading Mechanics Skill Development 620 and Trading Psychology Development there really can be very little true trading success. At the Trader Assessment And Group Assessment 682 a “More” determination may be made that the trader needs more or refinement of their Trading Mechanics Skill Development 620, Trading Psychology Development 630, or both. As before, the trader simply cycles through additional trading skill and trading psychology development in conjunction with continued trading followed by another Trader Assessment And Group Assessment 682. The trader or The Group may determine through a Continuation Assessment 694 that “Yes” the Student should continue with the Applicant's trading processes or “No” it would be appropriate for them to Discontinue 696 their trading activity, but it is unlikely at this time given the successes the trader has demonstrated in the markets. Again and as before, the trader may be assessed by the Trader Assessment And Group Assessment 682 that “No” further Applicant real money funding is not appropriate at this time and that the trader should continue to trade their current account essentially for further trading skill development, trading psychology development, or both. At an arbitrary time, a set time, or upon completion of a performance objective the trader can be reassess by the Trader Assessment and Group Assessment 682 for additional funding. A “Yes” determination may result that additional Applicant funding should occur where they are cycled back to the Run Amount Trading Account And Increases 680 for increased Applicant real money trading account funding. The trader continues to trade the new account amount and cycles through the Trader Assessment And Group Assessment 682 for additional funding at an arbitrary, specified time, or upon achievement of a trading objective. Upon assessment the trade may seek “More” trading skill development and trading psychology development as active traders are always learning. They may be assessed as a “No” simply continue with the current trade account amount and return for reassessment. An assessment may also determine that additional Applicant real money trade account deposits are appropriate, and the trader again is cycle back through the Run Amount Trading Account And Increases 680. This cycle simply repeats itself as determined appropriate by the trader and the Applicant for the benefit of earning a financial gain and further trading skill development and trading psychology development that continually reinforces a Proprietary Trading Outcome FIG. 2 294 that is a financial market participation result beyond Improved Trading Outcomes FIG. 2 284, and further beyond Typical Trading Outcomes FIG. 2 274.

FIG. 6 discloses the ultimate outcome of the Student, now trader, having progressed through the Applicant Multi-Faceted Trade Education And Experience Training 610. That is making a Trader Self-Funding Assessment 690. The ultimate goal is the training and development of financial market participants assessing that “Yes” they are interested and capable of Private Trade Account Funding 692. This flow chart does not imply that the Applicant will remove their funding, so the trader is capable of trading their Applicant Run Amount Trading Account And Increases 680 while also choosing to trade their Private Trade Account Funding 692. The trader is participating in the market with even greater trade account amounts for even further trading psychology development and trading gains. The trader may ask the question by Trader Self-Funding Assessment 690 if they are ready for Private Trade Account Funding 692. Any Continuation Assessment 694 at this point is a “Yes” to continue learning and trading, but they may assess “No” not to continue, but Discontinue 696 their participation. They may also assess that they need “More” Trading Mechanics Skill Development 620, Trading Psychology Development 630, or both. They simply continue to cycle through trading skill development, trading psychology development, or both in conjunction with continued trading until at such time they do assess by way of the Trader Self-Funding Assessment 690 that they are prepared for Private Trade Account Funding 692 and continue trading the Applicant's Real Money educational and Experiential Trading Account 650 at the same time for greater financial market participation and gains.

The Applicant's Multi-Faceted Trade Education And Experience Training 610 as detailed herein accompanied by Applicant Real Money Educational And Experiential Trading Account 650 produces a Proprietary Trading Outcomes FIG. 2 294 that is justifiably, but surprisingly effective. The Proprietary Trading Outcomes FIG. 2, 294 are the result of comprehensive Trading Mechanics Skill Development 620 combined with deliberate educational attention and deliberate real money financial market participation for Trading Psychology Development 630. The cyclical trading skill development and the cyclical trading psychology development in conjunction with increasing real money trading account creates environments that continually advances and draws out new levels of trading challenges and experience to address and advance through. Successful day trading requires continual development in trading mechanics or trading skill and trading psychology or the trader's relationship with the market. Without increasing development in both of these areas, there is only limited trading success in the markets. Ultimately, the Student becomes a trader more fully prepared to participate in the financial markets with a sizeable Applicant Real Money Educational And Experiential Trading Account 630 and ideally with the interest and confidence to additionally trade a Private trade Account Funding 692. The objective of Proprietary Trading Outcomes FIG. 2 294 for enhanced financial gain and market success is achieved and continued.

While the invention has been described with particular reference to the preferred embodiments, it will be understood by those skilled in the art that various changes may be made and equivalents may be substituted for elements of the preferred embodiments without departing from the invention. It is accordingly intended that the claims shall cover all such modifications and applications that do not depart from the true spirit and scope of the invention.

### SEQUENCE LISTING

Not applicable.

### REFERENCES

No references are included at this time.

### DRAWINGS

Separately submitted.

1. Trading psychology development method comprising:
the external financial market input data being streamed to a centralized manipulation center,
the centralized manipulation center providing trader device local market price candlestick display,
the local market price candlestick display being 1 minute to 10,080 minute periods,
the proprietary trading signal algorithms provided to the centralized manipulation center to be applied to the external financial market input data to provide trader device proprietary local graphic trading indicators,
the proprietary trading education combining the used of local market price candlestick display and proprietary local graphic trading indicators to create trader proprietary trading techniques, and
the trader proprietary trading techniques applied to the brokerage trading platform with a proprietary real money education fund trading account.

2. Trading psychology development of claim 1 comprising external financial market input data being from bond, cryptocurrency, commodity, foreign exchange, future, index, mutual fund, stocks, and equity markets.

3. Trading psychology development of claim 1 comprising local market price candlestick display preferably being 1 minute, 5 minute, 15 minute, 30 minute, 60 minute, 120 minute, 240 minute, 360 minute, 480 minute, 720 minute, 1,440 minute, and 10,080 minute charts.

4. Trading psychology development of claim 1 comprising local graphic trading indicators that are leading indicators to lagging indicators

5. Trading psychology development of claim 1 comprising proprietary trading education certified trade education and experience from 1-to-1 personal core instruction, small group instruction and side-by-side personal mastery instruction.

6. Trading psychology development of claim 1 comprising proprietary trading education ongoing trade education and experience from 1-to-1 personal core instruction, small group instruction, side-by-side personal mastery instruction, and large group event expert instruction.

7. Trading psychology development method comprising:
the external financial market input data being streamed to a centralized manipulation center,
the centralized manipulation center providing trader device local market price candlestick display,
the local market price candlestick display being 1 minute to 10,080 minute periods,
the proprietary trading signal algorithms provided to the centralized manipulation center to be applied to the external financial market input data to provide trader device proprietary local graphic trading indicators,
the proprietary trading education combining the used of local market price candlestick display and proprietary local graphic trading indicators to create trader proprietary trading techniques, and
the trader proprietary trading techniques applied to the brokerage trading platform with a proprietary real money education fund trading account,
the trade trial education and experience,
the prospect trade trial assessment of the trade trial education and experience to provide them a capacity to trade,
the group trade trial assessment of the prospect's capacity to trade,
the decision of the trade trial by the prospect and the group,
the certified practice account trading education and experience in applying trade mechanics,
the student assessment of a certified practice account trading and their capacity with trade mechanics,
the instructor assessment of a certified practice account trading and the student's abidance with trade mechanics,
the group assessment of a certified practice account trading and the student's abidance with trade mechanics,
the decision of student abidance with trade mechanics by the student, instructor, and the group,
the student's continued group trading education and experience in applying trade mechanics,
the real money educational trading account deposit,
the real money account trading education and experience,
the trader assessment of the real money account trading education in applying trade psychology,
the group assessment of the real money account trading education and experience in abidance with trade psychology,
the decision of trader abidance with trade psychology,
the student's continued real money trading education and experience, and
the confidence to initiate a private real money trading account.

8. Trading psychology development of claim 7 comprising certified practice account trading education and experience to include market information, core and advanced indicators, analysis skills, trade skills, and trade character.

9. Trading psychology development of claim 7 comprising trade mechanics to include trade technology, trade tools, trade techniques, and trade tips.

10. Trading psychology development of claim 7 comprising trade psychology to include trade plan, trade money management, trade consistency, trade discipline, trade patience, and trade management.

11. Trading psychology development of claim 7 comprising prospect trade trial assessment of yes being ready to advance, more education and experience is needed, or no to discontinue.

12. Trading psychology development of claim 7 comprising group trade trial assessment of yes being ready to advance, more education and experience is needed, or no to discontinue.

13. Trading psychology development of claim 7 comprising student assessment of a certified practice account trading being ready to advance, more education and experience is needed, or no to discontinue.

14. Trading psychology development of claim 7 comprising instructor assessment of a certified practice account trading being ready to advance, more education and experience is needed, or no to discontinue.

15. Trading psychology development of claim 7 comprising group assessment of a certified practice account trading being ready to advance, more education and experience is needed, or no to discontinue.

16. Trading psychology development of claim 7 comprising trader assessment of a real money account trading being ready to advance, more education and experience is needed, or no to discontinue.

17. Trading psychology development of claim 7 comprising group assessment of a real money account trading being ready to advance, more education and experience is needed, or no to discontinue.

18. Trading psychology development method comprising:
the external financial market input data being streamed to a centralized manipulation center,
the centralized manipulation center providing trader device local market price candlestick display,
the local market price candlestick display being 1 minute to 10,080 minute periods,
the proprietary trading signal algorithms provided to the centralized manipulation center to be applied to the external financial market input data to provide trader device proprietary local graphic trading indicators,
the proprietary trading education combining the used of local market price candlestick display and proprietary local graphic trading indicators to create trader proprietary trading techniques, and
the trader proprietary trading techniques applied to the brokerage trading platform with a proprietary real money education fund trading account,
the multi-faceted trade education and experience training,
the student trading assessment of abidance by the multi-faceted trade education and experience training,
the group trading assessment of abidance by the multi-faceted trade education and experience training,
the decision of student trading abidance to the multi-faceted trade education and experience training,
the student's continued availability of the multi-faceted trade education and experience training with trading mechanics skill development and trading psychology development,
the real money educational and experiential trading account deposit,
the first category of deposits being crawl level training and trade account funding real money educational and experiential trading account deposit being a smaller crawl level training and trade account funding for trading mechanics skills development and trading psychology development with a smaller real money account,
the trader trades the smaller crawl level training and trade account funding,
the crawl trader assessment of the smaller crawl level training and trade account funding for trader abidance with trading mechanics and trading psychology with a smaller real money account,
the crawl group assessment of the smaller crawl level training and trade account funding for trader abidance with trading mechanics and trading psychology with a smaller real money account,
the decision of trader smaller crawl level training and trade account funding abidance,
the trader's continued availability of the multi-faceted trade education and experience training,
the next category of deposits being an intermediate walk level training and trade account funding for trading mechanics skills development and trading psychology development with an intermediate walk real money account,
the trader trades the intermediate walk level training and trade account funding,
the walk trader assessment of the intermediate walk level training and trade account funding for trader abidance with trading mechanics and trading psychology with an intermediate real money account,
the walk group assessment of the intermediate walk level training and trade account funding for trader abidance with trading mechanics and trading psychology with an intermediate real money account,
the decision of trader intermediate walk level training and trade account funding abidance,
the trader's continued availability of the multi-faceted trade education and experience training,
the next category of deposits being a larger run level training and trade account funding for trading mechanics skills development and trading psychology development with a larger real money account,
the trader trades the larger run level training and trade account funding,
the walk trader assessment of the larger run level training and trade account funding for trader abidance with trading mechanics and trading psychology with an intermediate real money account,
the walk group assessment of the larger run level training and trade account funding for trader abidance with trading mechanics and trading psychology with an intermediate real money account,
the decision of trader larger run level training and trade account funding abidance,
the trader's continued availability of the multi-faceted trade education and experience training,
the confidence of the trader to initiate a trader self-funding assessment,
the trader to create a private trade account funding, and
the trader's continued availability of the multi-faceted trade education and experience training.

19. Trading psychology development of claim 18 comprising multi-faceted trade education and experience training of 1-to-1 personal core instruction, small group instruction, side-by-side personal mastery instruction, and large group even expert instruction using local market price candlestick display, proprietary local graphic trading tools, and proprietary trading techniques.

20. Trading psychology development of claim 18 comprising trade mechanics to include trade technology, trade tools, trade techniques, and trade tips.

21. Trading psychology development of claim 18 comprising trade psychology to include trade plan, trade money management, trade consistency, trade discipline, trade patience, and trade management.

22. Trading psychology development of claim 18 comprising trader assessment of the smaller real money crawl level training and trade account funding developing with relevant trading mechanics skill development and relevant trading psychology development being ready to advance in more real money, stay at the same amount of money, more education and experience is needed, or no to discontinue.

23. Trading psychology development of claim 18 comprising group assessment of the smaller real money crawl level training and trade account funding developing with relevant trading mechanics skill development and relevant trading psychology development being ready to advance in more real money, stay at the same amount of money, more education and experience is needed, or no to discontinue.

24. Trading psychology development of claim 18 comprising smaller crawl level training and trade account funding being $0 to $20,000.

25. Trading psychology development of claim 18 comprising trader assessment of the intermediate real money walk level training and trade account funding developing with relevant trading mechanics skill development and relevant trading psychology development being ready to advance in more real money, stay at the same amount of money, more education and experience is needed, or no to discontinue.

26. Trading psychology development of claim 18 comprising group assessment of the intermediate real money walk level training and trade account funding developing with relevant trading mechanics skill development and relevant trading psychology development being ready to advance in more real money, stay at the same amount of money, more education and experience is needed, or no to discontinue.

27. Trading psychology development of claim 18 comprising intermediate walk level training and trade account funding being $20,000 to $40,000.

28. Trading psychology development of claim 18 comprising trader assessment of the larger real money run level training and trade account funding developing with relevant trading mechanics skill development and relevant trading psychology development being ready to advance in more real money, stay at the same amount of money, more education and experience is needed, or no to discontinue.

29. Trading psychology development of claim 18 comprising group assessment of the larger real money run level training and trade account funding developing with relevant trading mechanics skill development and relevant trading psychology development being ready to advance in more real money, stay at the same amount of money, more education and experience is needed, or no to discontinue.

30. Trading psychology development of claim 18 comprising smaller run level training and trade account funding being $40,000 to $100,000.

31. Trading psychology development of claim 18 comprising trader self-funding assessment with relevant trading mechanics skill development and relevant trading psychology development being ready to advance into private trade account funding, stay with the run amount trading account and increases, more education and experience is needed, or no to discontinue.
